(19) United States
(12) Patent Application Publication
(10) Pub. No.: US 2022/0067626 A1
(43) Pub. Date: Mar. 3, 2022

(54) ENTERPRISE SPEND OPTIMIZATION AND MAPPING MODEL ARCHITECTURE

(71) Applicant: Honeywell International Inc., Charlotte, NC (US)

(72) Inventors: Senthil Kumar Unnikrishnan, Dunwoody, GA (US); Jan Zirnstein, Atlanta, GA (US); Vijay Kumar Ravi, Atlanta, GA (US); Weiqiang Mu, Alpharetta, GA (US); Ankur S. Manake, Charlotte, NC (US); Muthu Sabarethinam, Charlotte, NC (US); Chaitanya Krishna Reddy Charabuddi, Charlotte, NC (US); Michael Paul Carey, Charlotte, NC (US); Robert Mayer, Charlotte, NC (US); Mark Wahl, Charlotte, NC (US); Priya Hiteshkumar Ghetia, Bangalore (IN); Manoj Kumar, Atlanta, GA (US)

(21) Appl. No.: 17/462,396

(22) Filed: Aug. 31, 2021

Related U.S. Application Data
(60) Provisional application No. 63/072,560, filed on Aug. 31, 2020.
(60) Provisional application No. 63/149,004, filed on Feb. 12, 2021.

(51) Int. Cl. G06Q 10/06; G06F 16/2458; G06F 3/14

(52) U.S. Cl. CPC G06Q 10/06375; G06Q 30/0201; G06F 3/14; G06F 16/2465

(57) ABSTRACT

Various embodiments described herein relate to providing optimization related to enterprise performance management. In this regard, a request to obtain one or more insights with respect to a formatted version of disparate data associated with one or more data sources is received. The request includes an insight descriptor that describes a goal for the one or more insights. In response to the request, aspects of the formatted version of the disparate data is associated to provide the one or more insights. The associated aspects are determined by the goal and relationships between the aspects of the formatted version of the disparate data. Furthermore, one or more actions are performed based on the one or more insights.

### CROSS REFERENCE TO RELATED APPLICATIONS

This application claims the benefit of U.S. Provisional Application No. 63/072,560, titled “UNCLASSIFIED SPEND OPTIMIZATION,” filed Aug. 31, 2020, and U.S. Provisional Application No. 63/149,004, titled “ENTERPRISE SPEND OPTIMIZATION AND MAPPING MODEL ARCHITECTURE,” filed Feb. 12, 2021, the contents of which are hereby incorporated herein by reference in their entirety.

### TECHNICAL FIELD

The present disclosure relates generally to machine learning, and more particularly to optimization related to enterprise performance management.

### SUMMARY

In accordance with an embodiment of the present disclosure, a method is provided. The method provides for, at a device with one or more processors and a memory, receiving a request to obtain one or more insights with respect to a formatted version of disparate data associated with one or more data sources. The request comprises an insight descriptor describing a goal for the one or more insights. The method also provides for, at the device and in response to the request, correlating aspects of the formatted version of the disparate data to provide the one or more insights, the associated aspects determined by the goal and relationships between the aspects of the formatted version of the disparate data. The method also provides for, at the device and in response to the request, performing one or more actions based on the one or more insights.

In accordance with another embodiment of the present disclosure, a system is provided. The system comprises one or more processors, a memory, and one or more programs stored in the memory. The one or more programs include instructions configured to receive a request to obtain one or more insights with respect to a formatted version of disparate data associated with one or more data sources. The request comprises an insight descriptor describing a goal for the one or more insights. The one or more programs also include instructions configured to, in response to the request, correlate aspects of the formatted version of the disparate data to provide the one or more insights, the associated aspects determined by the goal and relationships between the aspects of the formatted version of the disparate data. The one or more programs also include instructions configured to, in response to the request, perform one or more actions based on the one or more insights.

In accordance with yet another embodiment of the present disclosure, a non-transitory computer-readable storage medium is provided. The non-transitory computer-readable storage medium comprises one or more programs for execution by one or more processors of a device. The one or more programs include instructions which, when executed by the one or more processors, cause the device to receive a request to obtain one or more insights with respect to a formatted version of disparate data associated with one or more data sources. The request comprises an insight descriptor describing a goal for the one or more insights. The one or more programs also include instructions which, when executed by the one or more processors, cause the device to, in response to the request, correlate aspects of the formatted version of the disparate data to provide the one or more insights, the associated aspects determined by the goal and relationships between the aspects of the formatted version of the disparate data. The one or more programs also include instructions which, when executed by the one or more processors, cause the device to, in response to the request, perform one or more actions based on the one or more insights.

### BACKGROUND

Traditionally, a majority amount of time (e.g., 60%-80% of time) related to data analytics and/or digital transformation of data involves cleaning and/or preparing the data for analysis. Furthermore, a limited amount of time is traditionally spent on modeling of the data to, for example, provide insights related to the data. As such, computing resources related to data analytics and/or digital transformation of data are traditionally employed in an inefficient manner.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 illustrates an exemplary networked computing system environment, in accordance with one or more embodiments described herein;

FIG. 2 illustrates a schematic block diagram of a framework of an IoT platform of the networked computing system, in accordance with one or more embodiments described herein;

FIG. 3 illustrates a system that provides an exemplary environment, in accordance with one or more embodiments described herein;

FIG. 4 illustrates another system that provides an exemplary environment, in accordance with one or more embodiments described herein;

FIG. 5 illustrates an exemplary computing device, in accordance with one or more embodiments described herein;

FIG. 6 illustrates a system for facilitating optimization related to enterprise performance management, in accordance with one or more embodiments described herein;

FIG. 7 illustrates a machine learning model, in accordance with one or more embodiments described herein;

FIG. 8 illustrates a system associated with an exemplary mapping model architecture, in accordance with one or more embodiments described herein;

FIG. 9 illustrates a system associated with another exemplary mapping model architecture, in accordance with one or more embodiments described herein;

FIG. 10 illustrates a system associated with an exemplary a transformer-based classification model, in accordance with one or more embodiments described herein;

FIG. 11 illustrates a system associated with an exemplary neural network architecture, in accordance with one or more embodiments described herein;

FIG. 12 illustrates a flow diagram for providing optimization related to enterprise performance management, in accordance with one or more embodiments described herein;

FIG. 13 illustrates a flow diagram for providing optimization related to enterprise performance management, in accordance with one or more embodiments described herein;

FIG. 14 illustrates a functional block diagram of a computer that may be configured to execute techniques described in accordance with one or more embodiments described herein;

FIG. 15 illustrates an exemplary user interface in accordance with one or more embodiments described herein;

FIG. 16 illustrates another exemplary user interface in accordance with one or more embodiments described herein; and

FIG. 17 illustrates yet another exemplary user interface in accordance with one or more embodiments described herein.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments. The term “or” is used herein in both the alternative and conjunctive sense, unless otherwise indicated. The terms “illustrative,” “example,” and “exemplary” are used to be examples with no indication of quality level. Like numbers refer to like elements throughout.

The phrases “in an embodiment,” “in one embodiment,” “according to one embodiment,” and the like generally mean that the particular feature, structure, or characteristic following the phrase can be included in at least one embodiment of the present disclosure, and can be included in more than one embodiment of the present disclosure (importantly, such phrases do not necessarily refer to the same embodiment).

The word “exemplary” is used herein to mean “serving as an example, instance, or illustration.” Any implementation described herein as “exemplary” is not necessarily to be construed as preferred or advantageous over other implementations.

If the specification states a component or feature “can,” “may,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature can be optionally included in some embodiments, or it can be excluded.

In general, the present disclosure provides for an “Internet-of-Things” or “IoT” platform for enterprise performance management that uses real-time models, near real-time models, and visual analytics to deliver intelligent actionable recommendations for sustained peak performance of an enterprise or organization. The IoT platform is an extensible platform that is portable for deployment in any cloud or data center environment for providing an enterprise-wide, top to bottom view, displaying the status of processes, assets, people, and safety. Further, the IoT platform of the present disclosure supports end-to-end capability to execute digital twins against process data and to translate the output into actionable insights, as detailed in the following description.

Traditionally, a majority amount of time (e.g., greater that 50% of the time, 60%-80% of time, and/or the like) related to data analytics and/or digital transformation of data involves cleaning and/or preparing the data for analysis. Furthermore, a limited amount of time is traditionally spent on modeling of the data to, for example, provide insights related to the data. As such, computing resources related to data analytics and/or digital transformation of data are traditionally employed in an inefficient manner.

As an example, enterprises often have procurement organizations to optimize spend (e.g., resource usage, asset usage, etc.) through various processes related to assets and/or services. However, it is generally difficult for procurement organizations to determine spend due to the scale (e.g., number of assets, number of parts, number of suppliers, etc.) and/or complexity (e.g., different geographic regions, different contracts, different vendors, etc.) of spend information for an enterprise. For instance, procurement specialists generally do not have all the context available for making decisions related to spend such as, for example, should a contract for an asset and/or service be negotiated for a 60 day payment term on or a 90 day payment term? Furthermore, it is generally difficult for procurement specialists to determine where to prioritize efforts to maximize value for an enterprise. For example, it is generally difficult for a procurement specialist to determine whether to renegotiate a contract for an asset and/or service, or to instead consolidate the asset and/or service. In this regard, traditional data analytics techniques generally result in inefficient usage of computing resources, an increased number of storage requirements, and/or an increased number of errors associated data. Moreover, traditional processing of data is generally not scalable as the complexity of the processing of the data is increased. It is also to be appreciated that other technical problems may also exist with respect to traditional data analytics and/or traditional digital transformation of data.

Thus, to address these and/or other issues, examples of optimization related to enterprise performance management is provided. Various embodiments described herein relate to unclassified data optimization for an enterprise. For instance, various embodiments described herein relate to unclassified spend optimization. The unclassified spend optimization includes, for example, unclassified spend optimization for an asset, unclassified spend optimization for an industrial plant, unclassified spend optimization for a warehouse, unclassified spend optimization for a building, unclassified spend optimization for an enterprise, and/or another type of unclassified spend optimization related to spend goals. Various embodiments described herein additionally or alternatively relate to unclassified asset optimization. Various embodiments described herein additionally or alternatively relate to optimization for supply chain analytics. For example, various embodiments described herein additionally or alternatively relate to optimization related to shipping conditions. Various embodiments described herein additionally or alternatively relate to other types of optimization related to enterprise performance management. The enterprise performance management includes, for example, performance management for an asset, performance management for an industrial plant, performance management for a warehouse, performance management for a building, performance management for an enterprise, and/or performance management another type of optimization goal. Various embodiments described herein additionally or alternatively provide a mapping model architecture related to formatting disparate data associated with the one or more data sources. Furthermore, in various embodiments described herein, one or more features associated with a format structure for disparate data are inferred to provide one or more mapping recommendations for a formatted version of the disparate data. In one or more embodiments, the one or more mapping recommendations facilitate transfer of data between a first data source and a second data source. In one or more embodiments, the one or more mapping recommendations facilitate one or more machine learning processes associated with the disparate data. In one or more embodiments, the one or more mapping recommendations facilitate providing one or more insights associated with the disparate data. In one or more embodiments, the one or more mapping recommendations facilitate execution of one or more actions based on the disparate data.

In various embodiments, the optimization related to enterprise performance management provides insights (e.g., actionable insights) across enterprise domains with scalable data liquidity. For example, in various embodiments, data driven opportunities are identified by employing intelligent data processing to generate value with respect to data in a reduced amount of time (e.g., seconds, minutes, hours, days or weeks) as compared to conventional data processing systems. In various embodiments, a data liquidity layer is provided across an enterprise by automating data integration with artificial intelligence to provide a network of knowledge that can be employed for data analytics and/or digital transformation for value creation with respect to data. In various embodiments, a multi-domain artificial intelligence offering is provided and/or is realized via one or more networks or cloud computing environments.

In various embodiments, data from one or more data sources (e.g., a relational data source, a data interchange data source, a comma-separated values data source, and/or another type of data source) is ingested to facilitate data preparation and/or data blending for the data. In various embodiments, one or more intelligent machine learning systems (e.g., one or more intelligent machine learning bots) map the data from different sources into a common data format. In various embodiments, a mapping file is employed to map each data field from data collected from a source to create a de-normalized database. In various embodiments, data deduping, rationalization, auto-filling, and/or anomaly detection with respect to the data is additionally or alternatively performed to facilitate data liquidity at scale. In various embodiments, enterprise semantics (e.g., industry semantics) is overlaid with respect to the data to provide real-world meaning across enterprise systems and/or to provide enterprise scale applications. In various embodiments, an artificial intelligence recommendation engine provides persona based recommendations on spend classification, product classification, product re-classification, payment terms optimization, risk mitigation, alternate supplier identification and/or other insights to provide enterprise optimization.

In various embodiments, data from one or more data sources is ingested, cleaned and aggregated to provide aggregated data. Furthermore, in various embodiments, one or more insights are determined from the aggregated data to provide cost savings and/or efficiency insights. In one or more embodiments, data is retrieved from one or more data sources and the data is unified in a single data lake. A data lake is, for example, a storage repository that stores data as raw data and/or in an original format for the data. In one or more embodiments, the data lake is updated at one or more predetermined intervals to keep data in the data lake up to date. According to one or more embodiments, the data in the data lake is made uniform by recognizing different fields in the data lake as describing the same subject (e.g., vendor name, payments terms, etc.) and/or by configuring all available terms (e.g., corresponding subjects) in the same format. In one or more embodiments, one or more operations are performed to complete data sources where field information is incomplete (e.g., by recognizing that a field that is missing is the same field in another data source where the information is complete, by using that information to supply the missing information, etc.).

In one or more embodiments, the data in the data lake is organized in an ontological structure. In one or more embodiments, the ontological structure allows complex structures associated with complex relationships between disparate data in the data lake to be understood (e.g., “show all vendors in a particular geographic location where the product supplied at the particular geographic location is dependent on commodity X,” “show all purchase orders where the shipment was made Y days late,” “show all industrial assets in an industrial plant where a certain degree of inefficiency exists during an interval of Z days,” “show all work order requests in an industrial plant where a maintenance delay resulted in a certain degree of inefficiency,” etc.). In one or more embodiments, based on the organized structure of the data lake, the data sources are periodically compared to identify and provide one or more opportunities for cost savings and/or efficiencies. For example, based on the organized structure of the data lake, it can be determined that payment terms for the same supplier are different in two different purchase orders and should be made the same. In another example, based on the organized structure of the data lake, it can be determined that the price of a commodity is cheaper from a second supplier. In yet another example, it can be determined that the cost of a commodity is cheaper on the open market and therefore it is more efficient to breach the current contract or renegotiate the current contract for the commodity. In yet another example, parts master data (e.g., a single source of parts) is created by ingesting data from multiple data sources to maintain different part numbers and/or to provide uniform visibility across the enterprise. In yet another example, a unified procurement database related to data from multiple enterprise systems is provided to facilitate metrics insights across the different enterprise systems.

In one or more embodiments, unclassified data for an organization is collected, cleansed and/or aggregated to facilitate delivery of one or more actions generated by one or more artificial intelligence (AI) models. According to various embodiments, the one or more AI models are employed to prioritize actions performed by a procurement organization to, for example, maximize value for the procurement organization. According to various embodiments, data mapping of unclassified data (e.g., unclassified data from multiple source systems) is performed to transform the unclassified data into an internal representation for employment by the one or more AI models. According to various embodiments, the one or more AI models are trained to determine one or more inferences and/or classifications for unclassified data.

In one or more embodiments, deep learning (e.g., deep learning associated with the one or more AI models) is performed to determine a part commodity family for unclassified purchase record data obtained from multiple data sources. According to one or more embodiments, the purchase record data includes, for example, purchase order data, vendor data (e.g., customer vendor data), invoice data, and/or other data. In an embodiment, the unclassified purchase record data is obtained from multiple external data sources. Additionally or alternately, in another embodiment, the unclassified purchase record data is obtained from a cloud database. Furthermore, in one or more embodiments, total spend for the part commodity family is aggregated to provide classified purchase record data. In one or more embodiments, one or more actions are performed based on the classified purchase record data.

In one or more embodiments, field mapping is employed for data migration between databases, data models and/or systems. In one or more embodiments, the field mapping employs entity relationships to facilitate data migration between databases, data models and/or systems. In one or more embodiments, the field mapping is automated to reduce an amount of time and/or to reduce an amount of computing resources for providing data migration between databases, data models and/or systems. In one or more embodiments, the field mapping is a hybrid solution that employs unsupervised machine learning and data insights (e.g., knowledge of data) to intelligently learn mappings between databases, data models and/or systems. In one or more embodiments, the field mapping employs a ground truth model, a mapping model based on field names, a mapping model based on field description, and/or a model for data features that are executed sequentially to generate mapping results between databases, data models and/or systems. In one or more embodiments, a mapping template for a first system (e.g., a target system), data schema of a second system (e.g., a legacy system), and/or data from the first system and the second system are employed to recommend one or more top matching data fields between the first system and the second system. In one or more embodiments, a mapping template for a first database, data schema of a second database, and/or data from the first database and the second database are employed to recommend one or more top matching data fields between the first database and the second database. In one or more embodiments, a mapping template for a first data model, data schema of a second data model, and/or data from the first data model and the second data model are employed to recommend one or more top matching data fields between the first data model and the second data model.

In one or more embodiments, a recurrent neural network is employed to map data into multi-dimensional word embeddings. In one or more embodiments, a network of gated-recurrent units of the recurrent neural network is employed to aggregate the total spend. According to one or more embodiments, the part commodity family is mapped to a supplier commodity classification based on part description data. Additionally or alternatively, in one or more embodiments, the part commodity family is mapped to a supplier commodity classification based on purchase order description data. Additionally or alternatively, in one or more embodiments, the part commodity family is mapped to a supplier commodity classification based on location data. Additionally or alternatively, in one or more embodiments, the part commodity family is mapped to a supplier commodity classification based on spend type data. Additionally or alternatively, in one or more embodiments, the part commodity family is mapped to a supplier commodity classification based on hierarchical data format technique.

In one or more embodiments, a column name-based model and/or a column value-based model is employed to facilitate mapping data into multi-dimensional word embeddings. In an embodiment, the column name-based model learns a vector representation of one or more defined target column names. The column name-based model also calculates similarity between source column names and the one or more defined target column names. The one or more defined target column names are configured, for example, as full name strings or name abbreviations. In one or more embodiments, input to the column name-based model includes one or more source column names and/or one or more defined target column names. According to various embodiments, the one or more source column names are auto identified from disparate data sources. Feature generation for the column name-based model includes, for example, generating text embeddings for column names for a source column and/or a target column. Furthermore, feature generation techniques for the column name-based model includes Term Frequency-Inverse Document Frequency (TF-IDF)+character-based n-gram, smooth inverse frequency (SIF), a library of learned word embeddings and/or text classifications, Universal Sentence Encoder, bidirectional encoder representations from transformers (BERT) embeddings, and/or one or more other feature generation techniques.

According to various embodiments, training of the column name-based model includes employment of a hierarchical classification model that includes a Level 1 associated with predicting dataset categories and a Level 2 associated with predicting corresponding column names using a predicted dataset category as a feature. According to various embodiments, training of the column name-based model additionally or alternatively includes employment of a multi-class classification model associated with one or more decision tree algorithms configured to predict a most probable mapping for source columns. According to various embodiments, the column name-based model is trained on known target data. Furthermore, as more data becomes available, the additional data is employed to include additional variations with respect to data characteristics to, for example, enhance performance of the column name-based model.

According to various embodiments, an inference related to the column name-based model includes preparing data by generating features for column names in the incoming dataset. A trained version of the column name-based model is employed to perform inference with respect to new data obtained from the disparate data sources. For columns that are unmapped, in one or more embodiments, a cosine similarity is employed to calculate a similarity score between pairs of source columns and target columns using, for example, unsupervised learning.

The column value-based model provides a mapping approach based on the column values for generating correct mappings. In an embodiment, the column value-based model employs a transformer model to train a text classifier. In one or more embodiments, a pre-trained model, such as a RoBERT(base) model, is fine-tuned by employing a dense layer on top of a last layer of a neural network. In one or more embodiments, the neural network of the column value-based model is trained on defined datasets with target column names and values. According to an embodiment, the neural network of the column value-based model includes a set of transformer encoder layers (e.g., 12 transformer encoder layers), a set of hidden sized representations (e.g., 768-hidden sized representations), and/or a set of attention heads (e.g., 12-attention heads). Input to the column value-based model includes one or more column values associated with an original source column name, a source column value, and/or a target column name. For instance, in an embodiment, input to the column value-based model includes a list of column values of all the source columns. Furthermore, output of the column value-based model includes a predicted target column mapping. In one or more values, raw text values undergo tokenization and/or input is formatted (e.g., obtaining tokens, segments, position, embeddings, padding, truncating, and/ attention masks) prior to being provided to the transformer model. In one or more embodiments, a RoBERTa classification model is employed with a single linear layer implemented on top of the model for classification associated with a text classifier. In one or more embodiments, as input data is provided to the column value-based model, a pre-trained RoBERTa model and/or one or more additional untrained classification layers are trained based on a target dataset. In one or more embodiments, a neural network architecture for the column value-based model includes providing an input column value to character level embedding, providing data from the character level embedding to a transformer, and providing data from the transformer to the classifier.

In one or more embodiments, a scoring model is employed based on different metrics from historical iterations to recommend the actions. In one or more embodiments, a user-interactive graphical user interface is generated. For instance, in one or more embodiments, the graphical user interface renders a visual representation of the classified purchase record data. In one or more embodiments, one or more notifications for user devices are generated based on the classified purchase record data. In one or more embodiments, at least a portion of the recurrent neural network is retrained based on the classified purchase record data.

As such, by employing one or more techniques disclosed herein, enterprise performance is optimized. For example, in one or more embodiments by employing one or more techniques disclosed herein, spend (e.g., unclassified spend) related to one or more assets and/or services is optimized. In another example, in one or more embodiments by employing one or more techniques disclosed herein, payment term optimization related to one or more assets and/or services is provided. In another example, in one or more embodiments by employing one or more techniques disclosed herein, an alternate supplier for one or more assets and/or services is determined. In another example, in one or more embodiments by employing one or more techniques disclosed herein, a shipping condition related to one or more assets and/or services is optimized. In another example, in one or more embodiments by employing one or more techniques disclosed herein, another goal insight related to one or more assets and/or services is determined. In addition, by employing one or more techniques disclosed herein, field mapping for formatting disparate data associated with one or more data sources is improved. Furthermore, by employing one or more techniques disclosed herein, quality of training data provided to an AI model is improved. Moreover, by employing one or more techniques disclosed herein, improved insights for unclassified data can be provided to a user via improved visual indicators associated with a graphical user interface. For instance, by employing one or more techniques disclosed herein, additional and/or improved insights as compared to capabilities of conventional techniques can be achieved across a data set. Additionally, performance of a processing system associated with data analytics is improved by employing one or more techniques disclosed herein. For example, a number of computing resources, a number of a storage requirements, and/or number of errors associated with data analytics is reduced by employing one or more techniques disclosed herein.

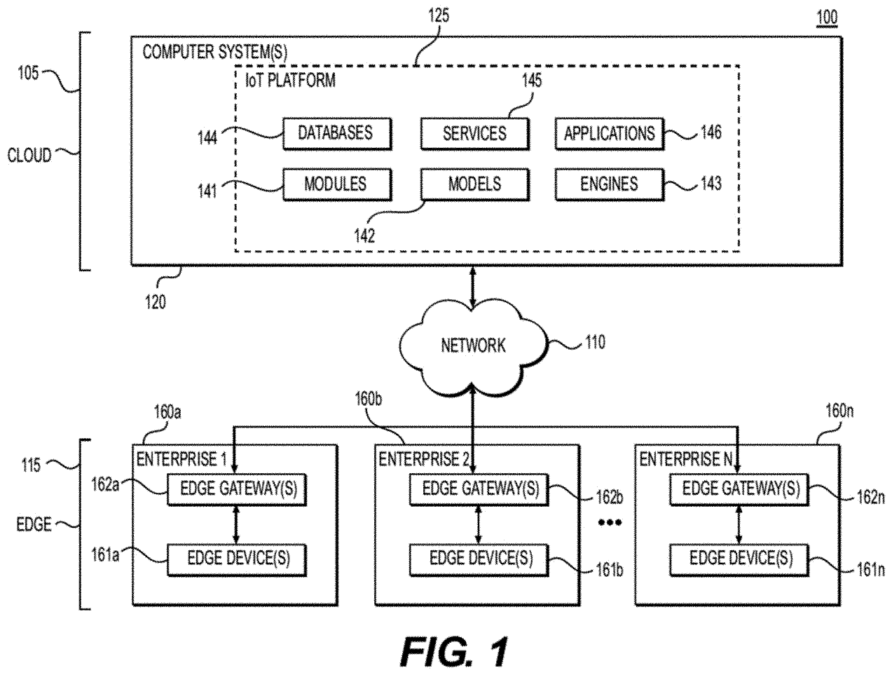

FIG. 1 illustrates an exemplary networked computing system environment 100, according to the present disclosure. As shown in FIG. 1, networked computing system environment 100 is organized into a plurality of layers including a cloud layer 105, a network layer 110, and an edge layer 115. As detailed further below, components of the edge 115 are in communication with components of the cloud 105 via network 110.

In various embodiments, network 110 is any suitable network or combination of networks and supports any appropriate protocol suitable for communication of data to and from components of the cloud 105 and between various other components in the networked computing system environment 100 (e.g., components of the edge 115). According to various embodiments, network 110 includes a public network (e.g., the Internet), a private network (e.g., a network within an organization), or a combination of public and/or private networks. According to various embodiments, network 110 is configured to provide communication between various components depicted in FIG. 1. According to various embodiments, network 110 comprises one or more networks that connect devices and/or components in the network layout to allow communication between the devices and/or components. For example, in one or more embodiments, the network 110 is implemented as the Internet, a wireless network, a wired network (e.g., Ethernet), a local area network (LAN), a Wide Area Network (WANs), Bluetooth, Near Field Communication (NFC), or any other type of network that provides communications between one or more components of the network layout. In some embodiments, network 110 is implemented using cellular networks, satellite, licensed radio, or a combination of cellular, satellite, licensed radio, and/or unlicensed radio networks.

Components of the cloud 105 include one or more computer systems 120 that form a so-called “Internet-of-Things” or “IoT” platform 125. It should be appreciated that “IoT platform” is an optional term describing a platform connecting any type of Internet-connected device, and should not be construed as limiting on the types of computing systems useable within IoT platform 125. In particular, in various embodiments, computer systems 120 includes any type or quantity of one or more processors and one or more data storage devices comprising memory for storing and executing applications or software modules of networked computing system environment 100. In one embodiment, the processors and data storage devices are embodied in server-class hardware, such as enterprise-level servers. For example, in an embodiment, the processors and data storage devices comprises any type or combination of application servers, communication servers, web servers, super-computing servers, database servers, file servers, mail servers, proxy servers, and/virtual servers. Further, the one or more processors are configured to access the memory and execute processor-readable instructions, which when executed by the processors configures the processors to perform a plurality of functions of the networked computing system environment 100.

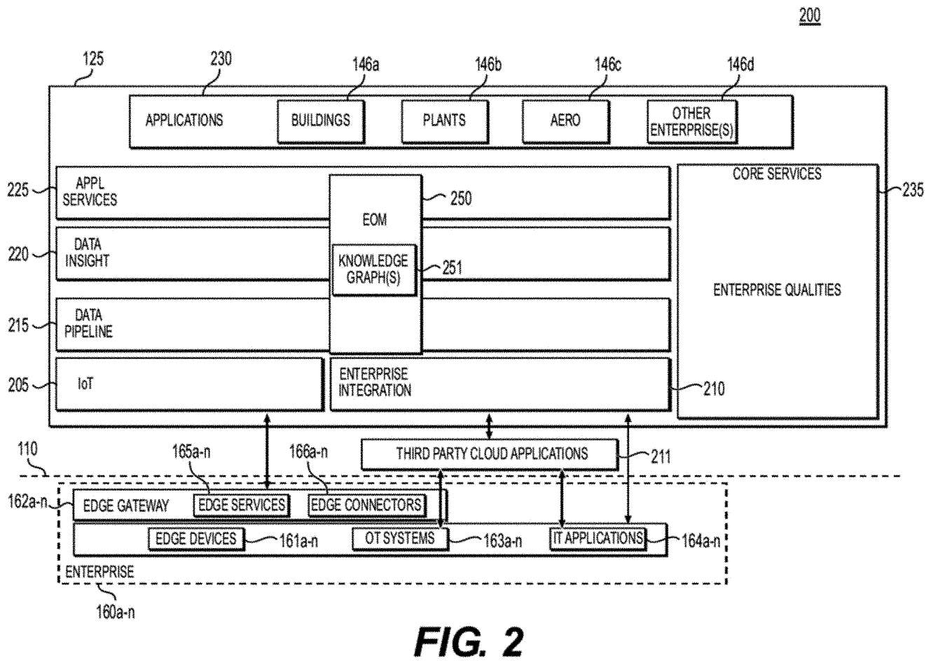

Computer systems 120 further include one or more software components of the IoT platform 125. For example, in one or more embodiments, the software components of computer systems 120 include one or more software modules to communicate with user devices and/or other computing devices through network 110. For example, in one or more embodiments, the software components include one or more modules 141, models 142, engines 143, databases 144, services 145, and/or applications 146, which may be stored in/by the computer systems 120 (e.g., stored on the memory), as detailed with respect to FIG. 2 below. According to various embodiments, the one or more processors are configured to utilize the one or more modules 141, models 142, engines 143, databases 144, services 145, and/or applications 146 when performing various methods described in this disclosure.

Accordingly, in one or more embodiments, computer systems 120 execute a cloud computing platform (e.g., IoT platform 125) with scalable resources for computation and/or data storage, and may run one or more applications on the cloud computing platform to perform various computer-implemented methods described in this disclosure. In some embodiments, some of the modules 141, models 142, engines 143, databases 144, services 145, and/or applications 146 are combined to form fewer modules, models, engines, databases, services, and/or applications. In some embodiments, some of the modules 141, models 142, engines 143, databases 144, services 145, and/or applications 146 are separated into separate, more numerous modules, models, engines, databases, services, and/or applications. In some embodiments, some of the modules 141, models 142, engines 143, databases 144, services 145, and/or applications 146 are removed while others are added.

The computer systems 120 are configured to receive data from other components (e.g., components of the edge 115) of networked computing system environment 100 via network 110. Computer systems 120 are further configured to utilize the received data to produce a result. According to various embodiments, information indicating the result is transmitted to users via user computing devices over network 110. In some embodiments, the computer systems 120 is a server system that provides one or more services including providing the information indicating the received data and/or the result(s) to the users. According to various embodiments, computer systems 120 are part of an entity which include any type of company, organization, or institution that implements one or more IoT services. In some examples, the entity is an IoT platform provider.

Components of the edge 115 include one or more enterprises 160a-160n each including one or more edge devices 161a-161n and one or more edge gateways 162a-162n. For example, a first enterprise 160a includes first edge devices 161a and first edge gateways 162a, a second enterprise 160b includes second edge devices 161b and second edge gateways 162b, and an nth enterprise 160n includes nth edge devices 161n and nth edge gateways 162n. As used herein, enterprises 160a-160n represent any type of entity, facility, or vehicle, such as, for example, companies, divisions, buildings, manufacturing plants, warehouses, real estate facilities, laboratories, aircraft, spacecraft, automobiles, ships, boats, military vehicles, oil and gas facilities, or any other type of entity, facility, and/or vehicle that includes any number of local devices.

According to various embodiments, the edge devices 161a-161n represent any of a variety of different types of devices that may be found within the enterprises 160a-160n. Edge devices 161a-161n are any type of device configured to access network 110, or be accessed by other devices through network 110, such as via an edge gateway 162a-162n. According to various embodiments, edge devices 161a-161n are “IoT devices” which include any type of network-connected (e.g., Internet-connected) device. For example, in one or more embodiments, the edge devices 161a-161n include sensors, actuators, processors, computers, valves, pumps, ducts, vehicle components, cameras, displays, doors, windows, security components, HVAC components, factory equipment, and/or any other devices that are connected to the network 110 for collecting, sending, and/or receiving information. Each edge device 161a-161n includes, or is otherwise in communication with, one or more controllers for selectively controlling a respective edge device 161a-161n and/or for sending/receiving information between the edge devices 161a-161n and the cloud 105 via network 110. With reference to FIG. 2, in one or more embodiments, the edge 115 include operational technology (OT) systems 163a-163n and information technology (IT) applications 164a-164n of each enterprise 161a-161n. The OT systems 163a-163n include hardware and software for detecting and/or causing a change, through the direct monitoring and/or control of industrial equipment (e.g., edge devices 161a-161n), assets, processes, and/or events. The IT applications 164a-164n includes network, storage, and computing resources for the generation, management, storage, and delivery of data throughout and between organizations.

The edge gateways 162a-162n include devices for facilitating communication between the edge devices 161a-161n and the cloud 105 via network 110. For example, the edge gateways 162a-162n include one or more communication interfaces for communicating with the edge devices 161a-161n and for communicating with the cloud 105 via network 110. According to various embodiments, the communication interfaces of the edge gateways 162a-162n include one or more cellular radios, Bluetooth, WiFi, near-field communication radios, Ethernet, or other appropriate communication devices for transmitting and receiving information. According to various embodiments, multiple communication interfaces are included in each gateway 162a-162n for providing multiple forms of communication between the edge devices 161a-161n, the gateways 162a-162n, and the cloud 105 via network 110. For example, in one or more embodiments, communication are achieved with the edge devices 161a-161n and/or the network 110 through wireless communication (e.g., WiFi, radio communication, etc.) and/or a wired data connection (e.g., a universal serial bus, an onboard diagnostic system, etc.) or other communication modes, such as a local area network (LAN), wide area network (WAN) such as the Internet, a telecommunications network, a data network, or any other type of network.

According to various embodiments, the edge gateways 162a-162n also include a processor and memory for storing and executing program instructions to facilitate data processing. For example, in one or more embodiments, the edge gateways 162a-162n are configured to receive data from the edge devices 161a-161n and process the data prior to sending the data to the cloud 105. Accordingly, in one or more embodiments, the edge gateways 162a-162n include one or more software modules or components for providing data processing services and/or other services or methods of the present disclosure. With reference to FIG. 2, each edge gateway 162a-162n includes edge services 165a-165n and edge connectors 166a-166n. According to various embodiments, the edge services 165a-165n include hardware and software components for processing the data from the edge devices 161a-161n. According to various embodiments, the edge connectors 166a-166n include hardware and software components for facilitating communication between the edge gateway 162a-162n and the cloud 105 via network 110, as detailed above. In some cases, any of edge devices 161a-n, edge connectors 166a-n, and edge gateways 162a-n have their functionality combined, omitted, or separated into any combination of devices. In other words, an edge device and its connector and gateway need not necessarily be discrete devices.

FIG. 2 illustrates a schematic block diagram of framework 200 of the IoT platform 125, according to the present disclosure. The IoT platform 125 of the present disclosure is a platform for enterprise performance management that uses real-time accurate models and visual analytics to deliver intelligent actionable recommendations for sustained peak performance of the enterprise 160a-160n. The IoT platform 125 is an extensible platform that is portable for deployment in any cloud or data center environment for providing an enterprise-wide, top to bottom view, displaying the status of processes, assets, people, and safety. Further, the IoT platform 125 supports end-to-end capability to execute digital twins against process data and to translate the output into actionable insights, using the framework 200, detailed further below.

As shown in FIG. 2, the framework 200 of the IoT platform 125 comprises a number of layers including, for example, an IoT layer 205, an enterprise integration layer 210, a data pipeline layer 215, a data insight layer 220, an application services layer 225, and an applications layer 230. The IoT platform 125 also includes a core services layer 235 and an extensible object model (EOM) 250 comprising one or more knowledge graphs 251. The layers 205-235 further include various software components that together form each layer 205-235. For example, in one or more embodiments, each layer 205-235 includes one or more of the modules 141, models 142, engines 143, databases 144, services 145, applications 146, or combinations thereof. In some embodiments, the layers 205-235 are combined to form fewer layers. In some embodiments, some of the layers 205-235 are separated into separate, more numerous layers. In some embodiments, some of the layers 205-235 are removed while others may be added.

The IoT platform 125 is a model-driven architecture. Thus, the extensible object model 250 communicates with each layer 205-230 to contextualize site data of the enterprise 160a-160n using an extensible object model (or “asset model”) and knowledge graphs 251 where the equipment (e.g., edge devices 161a-161n) and processes of the enterprise 160a-160n are modeled. The knowledge graphs 251 of EOM 250 are configured to store the models in a central location. The knowledge graphs 251 define a collection of nodes and links that describe real-world connections that enable smart systems. As used herein, a knowledge graph 251: (i) describes real-world entities (e.g., edge devices 161a-161n) and their interrelations organized in a graphical interface; (ii) defines possible classes and relations of entities in a schema; (iii) enables interrelating arbitrary entities with each other; and (iv) covers various topical domains. In other words, the knowledge graphs 251 define large networks of entities (e.g., edge devices 161a-161n), semantic types of the entities, properties of the entities, and relationships between the entities. Thus, the knowledge graphs 251 describe a network of “things” that are relevant to a specific domain or to an enterprise or organization. Knowledge graphs 251 are not limited to abstract concepts and relations, but can also contain instances of objects, such as, for example, documents and datasets. In some embodiments, the knowledge graphs 251 include resource description framework (RDF) graphs. As used herein, a “RDF graph” is a graph data model that formally describes the semantics, or meaning, of information. The RDF graph also represents metadata (e.g., data that describes data). According to various embodiments, knowledge graphs 251 also include a semantic object model. The semantic object model is a subset of a knowledge graph 251 that defines semantics for the knowledge graph 251. For example, the semantic object model defines the schema for the knowledge graph 251.

As used herein, EOM 250 is a collection of application programming interfaces (APIs) that enables seeded semantic object models to be extended. For example, the EOM 250 of the present disclosure enables a customer's knowledge graph 251 to be built subject to constraints expressed in the customer's semantic object model. Thus, the knowledge graphs 251 are generated by customers (e.g., enterprises or organizations) to create models of the edge devices 161a-161n of an enterprise 160a-160n, and the knowledge graphs 251 are input into the EOM 250 for visualizing the models (e.g., the nodes and links).

The models describe the assets (e.g., the nodes) of an enterprise (e.g., the edge devices 161a-161n) and describe the relationship of the assets with other components (e.g., the links). The models also describe the schema (e.g., describe what the data is), and therefore the models are self-validating. For example, in one or more embodiments, the model describes the type of sensors mounted on any given asset (e.g., edge device 161a-161n) and the type of data that is being sensed by each sensor. According to various embodiments, a key performance indicator (KPI) framework is used to bind properties of the assets in the extensible object model 250 to inputs of the KPI framework. Accordingly, the IoT platform 125 is an extensible, model-driven end-to-end stack including: two-way model sync and secure data exchange between the edge 115 and the cloud 105, metadata driven data processing (e.g., rules, calculations, and aggregations), and model driven visualizations and applications. As used herein, “extensible” refers to the ability to extend a data model to include new properties/columns/fields, new classes/tables, and new relations. Thus, the IoT platform 125 is extensible with regards to edge devices 161a-161n and the applications 146 that handle those devices 161a-161n. For example, when new edge devices 161a-161n are added to an enterprise 160a-160n system, the new devices 161a-161n will automatically appear in the IoT platform 125 so that the corresponding applications 146 understand and use the data from the new devices 161a-161n.

In some cases, asset templates are used to facilitate configuration of instances of edge devices 161a-161n in the model using common structures. An asset template defines the typical properties for the edge devices 161a-161n of a given enterprise 160a-160n for a certain type of device. For example, an asset template of a pump includes modeling the pump having inlet and outlet pressures, speed, flow, etc. The templates may also include hierarchical or derived types of edge devices 161a-161n to accommodate variations of a base type of device 161a-161n. For example, a reciprocating pump is a specialization of a base pump type and would include additional properties in the template. Instances of the edge device 161a-161n in the model are configured to match the actual, physical devices of the enterprise 160a-160n using the templates to define expected attributes of the device 161a-161n. Each attribute is configured either as a static value (e.g., capacity is 1000 BPH) or with a reference to a time series tag that provides the value. The knowledge graph 250 can automatically map the tag to the attribute based on naming conventions, parsing, and matching the tag and attribute descriptions and/or by comparing the behavior of the time series data with expected behavior.

The modeling phase includes an onboarding process for syncing the models between the edge 115 and the cloud 105. For example, in one or more embodiments, the onboarding process includes a simple onboarding process, a complex onboarding process, and/or a standardized rollout process. The simple onboarding process includes the knowledge graph 250 receiving raw model data from the edge 115 and running context discovery algorithms to generate the model. The context discovery algorithms read the context of the edge naming conventions of the edge devices 161a-161n and determine what the naming conventions refer to. For example, in one or more embodiments, the knowledge graph 250 receives “TMP” during the modeling phase and determine that “TMP” relates to “temperature.” The generated models are then published. The complex onboarding process includes the knowledge graph 250 receiving the raw model data, receiving point history data, and receiving site survey data. According to various embodiments, the knowledge graph 250 then uses these inputs to run the context discovery algorithms. According to various embodiments, the generated models are edited and then the models are published. The standardized rollout process includes manually defining standard models in the cloud 105 and pushing the models to the edge 115.

The IoT layer 205 includes one or more components for device management, data ingest, and/or command/control of the edge devices 161a-161n. The components of the IoT layer 205 enable data to be ingested into, or otherwise received at, the IoT platform 125 from a variety of sources. For example, in one or more embodiments, data is ingested from the edge devices 161a-161n through process historians or laboratory information management systems. The IoT layer 205 is in communication with the edge connectors 165a-165n installed on the edge gateways 162a-162n through network 110, and the edge connectors 165a-165n send the data securely to the IoT platform 205. In some embodiments, only authorized data is sent to the IoT platform 125, and the IoT platform 125 only accepts data from authorized edge gateways 162a-162n and/or edge devices 161a-161n. According to various embodiments, data is sent from the edge gateways 162a-162n to the IoT platform 125 via direct streaming and/or via batch delivery. Further, after any network or system outage, data transfer will resume once communication is re-established and any data missed during the outage will be backfilled from the source system or from a cache of the IoT platform 125. According to various embodiments, the IoT layer 205 also includes components for accessing time series, alarms and events, and transactional data via a variety of protocols.

The enterprise integration layer 210 includes one or more components for events/messaging, file upload, and/or REST/OData. The components of the enterprise integration layer 210 enable the IoT platform 125 to communicate with third party cloud applications 211, such as any application(s) operated by an enterprise in relation to its edge devices. For example, the enterprise integration layer 210 connects with enterprise databases, such as guest databases, customer databases, financial databases, patient databases, etc. The enterprise integration layer 210 provides a standard application programming interface (API) to third parties for accessing the IoT platform 125. The enterprise integration layer 210 also enables the IoT platform 125 to communicate with the OT systems 163a-163n and IT applications 164a-164n of the enterprise 160a-160n. Thus, the enterprise integration layer 210 enables the IoT platform 125 to receive data from the third-party applications 211 rather than, or in combination with, receiving the data from the edge devices 161a-161n directly.

The data pipeline layer 215 includes one or more components for data cleansing/enriching, data transformation, data calculations/aggregations, and/or API for data streams. Accordingly, in one or more embodiments, the data pipeline layer 215 pre-processes and/or performs initial analytics on the received data. The data pipeline layer 215 executes advanced data cleansing routines including, for example, data correction, mass balance reconciliation, data conditioning, component balancing and simulation to ensure the desired information is used as a basis for further processing. The data pipeline layer 215 also provides advanced and fast computation. For example, cleansed data is run through enterprise-specific digital twins. According to various embodiments, the enterprise-specific digital twins include a reliability advisor containing process models to determine the current operation and the fault models to trigger any early detection and determine an appropriate resolution. According to various embodiments, the digital twins also include an optimization advisor that integrates real-time economic data with real-time process data, selects the right feed for a process, and determines optimal process conditions and product yields.

According to various embodiments, the data pipeline layer 215 employs models and templates to define calculations and analytics. Additionally or alternatively, according to various embodiments, the data pipeline layer 215 employs models and templates to define how the calculations and analytics relate to the assets (e.g., the edge devices 161a-161n). For example, in an embodiment, a pump template defines pump efficiency calculations such that every time a pump is configured, the standard efficiency calculation is automatically executed for the pump. The calculation model defines the various types of calculations, the type of engine that should run the calculations, the input and output parameters, the preprocessing requirement and prerequisites, the schedule, etc. According to various embodiments, the actual calculation or analytic logic is defined in the template or it may be referenced. Thus, according to various embodiments, the calculation model is employed to describe and control the execution of a variety of different process models. According to various embodiments, calculation templates are linked with the asset templates such that when an asset (e.g., edge device 161a-161n) instance is created, any associated calculation instances are also created with their input and output parameters linked to the appropriate attributes of the asset (e.g., edge device 161a-161n).

According to various embodiments, the IoT platform 125 supports a variety of different analytics models including, for example, first principles models, empirical models, engineered models, user-defined models, machine learning models, built-in functions, and/or any other types of analytics models. Fault models and predictive maintenance models will now be described by way of example, but any type of models may be applicable.

Fault models are used to compare current and predicted enterprise 160a-160n performance to identify issues or opportunities, and the potential causes or drivers of the issues or opportunities. The IoT platform 125 includes rich hierarchical symptom-fault models to identify abnormal conditions and their potential consequences. For example, in one or more embodiments, the IoT platform 125 drill downs from a high-level condition to understand the contributing factors, as well as determining the potential impact a lower level condition may have. There may be multiple fault models for a given enterprise 160a-160n looking at different aspects such as process, equipment, control, and/or operations. According to various embodiments, each fault model identifies issues and opportunities in their domain, and can also look at the same core problem from a different perspective. According to various embodiments, an overall fault model is layered on top to synthesize the different perspectives from each fault model into an overall assessment of the situation and point to the true root cause.

According to various embodiments, when a fault or opportunity is identified, the IoT platform 125 provides recommendations about an optimal corrective actions to take. Initially, the recommendations are based on expert knowledge that has been pre-programmed into the system by process and equipment experts. A recommendation services module presents this information in a consistent way regardless of source, and supports workflows to track, close out, and document the recommendation follow-up. According to various embodiments, the recommendation follow-up is employed to improve the overall knowledge of the system over time as existing recommendations are validated (or not) or new cause and effect relationships are learned by users and/or analytics.

According to various embodiments, the models are used to accurately predict what will occur before it occurs and interpret the status of the installed base. Thus, the IoT platform 125 enables operators to quickly initiate maintenance measures when irregularities occur. According to various embodiments, the digital twin architecture of the IoT platform 125 employs a variety of modeling techniques. According to various embodiments, the modeling techniques include, for example, rigorous models, fault detection and diagnostics (FDD), descriptive models, predictive maintenance, prescriptive maintenance, process optimization, and/or any other modeling technique.

According to various embodiments, the rigorous models are converted from process design simulation. In this manner, process design is integrated with feed conditions and production requirement. Process changes and technology improvement provide business opportunities that enable more effective maintenance schedule and deployment of resources in the context of production needs. The fault detection and diagnostics include generalized rule sets that are specified based on industry experience and domain knowledge and can be easily incorporated and used working together with equipment models. According to various embodiments, the descriptive models identifies a problem and the predictive models determines possible damage levels and maintenance options. According to various embodiments, the descriptive models include models for defining the operating windows for the edge devices 161a-161n.

Predictive maintenance includes predictive analytics models developed based on rigorous models and statistic models, such as, for example, principal component analysis (PCA) and partial least square (PLS). According to various embodiments, machine learning methods are applied to train models for fault prediction. According to various embodiments, predictive maintenance leverages FDD-based algorithms to continuously monitor individual control and equipment performance. Predictive modeling is then applied to a selected condition indicator that deteriorates in time. Prescriptive maintenance includes determining an optimal maintenance option and when it should be performed based on actual conditions rather than time-based maintenance schedule. According to various embodiments, prescriptive analysis selects the right solution based on the company's capital, operational, and/or other requirements. Process optimization is determining optimal conditions via adjusting set-points and schedules. The optimized set-points and schedules can be communicated directly to the underlying controllers, which enables automated closing of the loop from analytics to control.

The data insight layer 220 includes one or more components for time series databases (TDSB), relational/document databases, data lakes, blob, files, images, and videos, and/or an API for data query. According to various embodiments, when raw data is received at the IoT platform 125, the raw data is stored as time series tags or events in warm storage (e.g., in a TSDB) to support interactive queries and to cold storage for archive purposes. According to various embodiments, data is sent to the data lakes for offline analytics development. According to various embodiments, the data pipeline layer 215 accesses the data stored in the databases of the data insight layer 220 to perform analytics, as detailed above.

The application services layer 225 includes one or more components for rules engines, workflow/notifications, KPI framework, insights (e.g., actionable insights), decisions, recommendations, machine learning, and/or an API for application services. The application services layer 225 enables building of applications 146a-d. The applications layer 230 includes one or more applications 146a-d of the IoT platform 125. For example, according to various embodiments, the applications 146a-d includes a buildings application 146a, a plants application 146b, an aero application 146c, and other enterprise applications 146d. According to various embodiments, the applications 146 includes general applications 146 for portfolio management, asset management, autonomous control, and/or any other custom applications. According to various embodiments, portfolio management includes the KPI framework and a flexible user interface (UI) builder. According to various embodiments, asset management includes asset performance and asset health. According to various embodiments, autonomous control includes energy optimization and/or predictive maintenance. As detailed above, according to various embodiments, the general applications 146 is extensible such that each application 146 is configurable for the different types of enterprises 160a-160n (e.g., buildings application 146a, plants application 146b, aero application 146c, and other enterprise applications 146d).

The applications layer 230 also enables visualization of performance of the enterprise 160a-160n. For example, dashboards provide a high-level overview with drill downs to support deeper investigations. Recommendation summaries give users prioritized actions to address current or potential issues and opportunities. Data analysis tools support ad hoc data exploration to assist in troubleshooting and process improvement.

The core services layer 235 includes one or more services of the IoT platform 125. According to various embodiments, the core services 235 include data visualization, data analytics tools, security, scaling, and monitoring. According to various embodiments, the core services 235 also include services for tenant provisioning, single login/common portal, self-service admin, UI library/UI tiles, identity/access/entitlements, logging/monitoring, usage metering, API gateway/dev portal, and the IoT platform 125 streams.

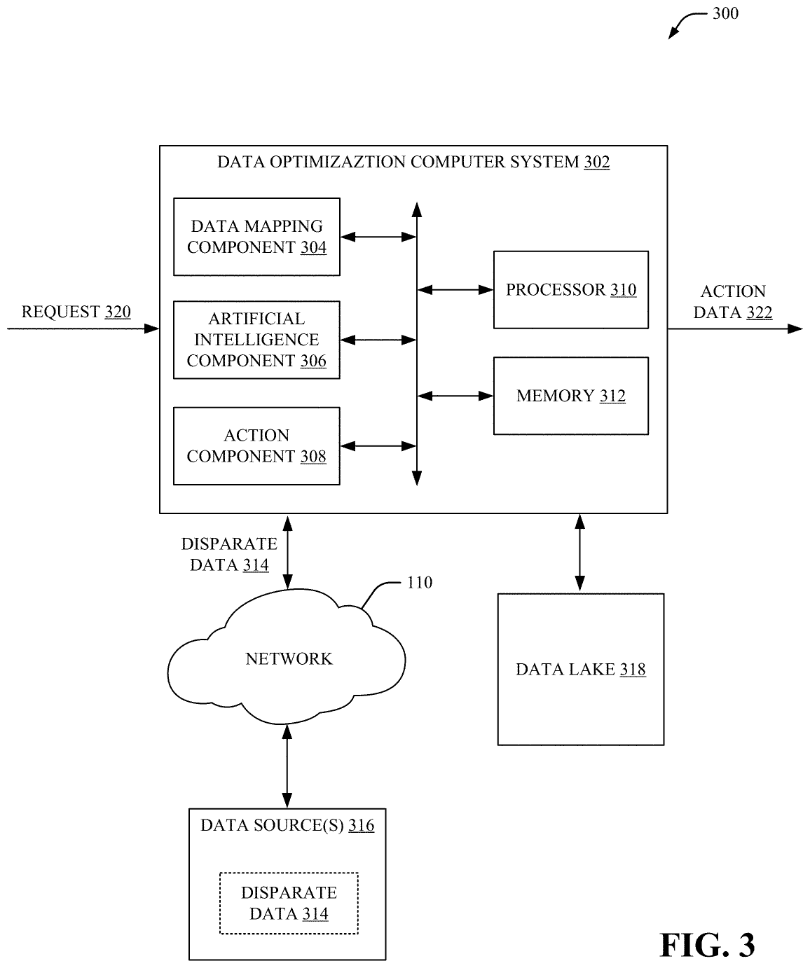

FIG. 3 illustrates a system 300 that provides an exemplary environment according to one or more described features of one or more embodiments of the disclosure. According to an embodiment, the system 300 includes a data optimization computer system 302 to facilitate a practical application of data analytics technology and/or digital transformation technology to provide optimization related to enterprise performance management. In one or more embodiments, the data optimization computer system 302 facilitates a practical application of machine learning technology to provide optimization related to enterprise performance management. In one or more embodiments, the data optimization computer system 302 analyzes data that is ingested, cleaned and/or aggregated from one or more information technology data sources to provide cost saving insights and/or efficiency insights for an enterprise system.

In an embodiment, the data optimization computer system 302 is a server system (e.g., a server device) that facilitates a data analytics platform between one or more computing devices and one or more data sources. In one or more embodiments, the data optimization computer system 302 is a device with one or more processors and a memory. In one or more embodiments, the data optimization computer system 302 is a computer system from the computer systems 120. For example, in one or more embodiments, the data optimization computer system 302 is implemented via the cloud 105. The data optimization computer system 302 is also related to one or more technologies, such as, for example, enterprise technologies, data analytics technologies, digital transformation technologies, cloud computing technologies, cloud database technologies, server technologies, network technologies, wireless communication technologies, natural language processing technologies, machine learning technologies, artificial intelligence technologies, digital processing technologies, electronic device technologies, computer technologies, industrial technologies, industrial Internet of Things (IoT) technologies, supply chain analytics technologies, aircraft technologies, building technologies, cybersecurity technologies, navigation technologies, asset visualization technologies, oil and gas technologies, petrochemical technologies, refinery technologies, process plant technologies, procurement technologies, and/or one or more other technologies.

Moreover, the data optimization computer system 302 provides an improvement to one or more technologies such as enterprise technologies, data analytics technologies, digital transformation technologies, cloud computing technologies, cloud database technologies, server technologies, network technologies, wireless communication technologies, natural language processing technologies, machine learning technologies, artificial intelligence technologies, digital processing technologies, electronic device technologies, computer technologies, industrial technologies, industrial Internet of Things (IoT) technologies, supply chain analytics technologies, aircraft technologies, building technologies, cybersecurity technologies, navigation technologies, asset visualization technologies, oil and gas technologies, petrochemical technologies, refinery technologies, process plant technologies, procurement technologies, and/or one or more other technologies. In an implementation, the data optimization computer system 302 improves performance of a computing device. For example, in one or more embodiments, the data optimization computer system 302 improves processing efficiency of a computing device (e.g., a server), reduces power consumption of a computing device (e.g., a server), improves quality of data provided by a computing device (e.g., a server), etc.

The data optimization computer system 302 includes a data mapping component 304, an artificial intelligence component 306 and/or an action component 308. Additionally, in certain embodiments, the data optimization computer system 302 includes a processor 310 and/or a memory 312. In certain embodiments, one or more aspects of the data optimization computer system 302 (and/or other systems, apparatuses and/or processes disclosed herein) constitute executable instructions embodied within a computer-readable storage medium (e.g., the memory 312). For instance, in an embodiment, the memory 312 stores computer executable component and/or executable instructions (e.g., program instructions). Furthermore, the processor 310 facilitates execution of the computer executable components and/or the executable instructions (e.g., the program instructions). In an example embodiment, the processor 310 is configured to execute instructions stored in the memory 312 or otherwise accessible to the processor 310.

The processor 310 is a hardware entity (e.g., physically embodied in circuitry) capable of performing operations according to one or more embodiments of the disclosure. Alternatively, in an embodiment where the processor 310 is embodied as an executor of software instructions, the software instructions configure the processor 310 to perform one or more algorithms and/or operations described herein in response to the software instructions being executed. In an embodiment, the processor 310 is a single core processor, a multi-core processor, multiple processors internal to the data optimization computer system 302, a remote processor (e.g., a processor implemented on a server), and/or a virtual machine. In certain embodiments, the processor 310 is in communication with the memory 312, the data mapping component 304, the artificial intelligence component 306 and/or the action component 308 via a bus to, for example, facilitate transmission of data among the processor 310, the memory 312, the data mapping component 304, the artificial intelligence component 306 and/or the action component 308. The processor 310 may embodied in a number of different ways and can, in certain embodiments, includes one or more processing devices configured to perform independently. Additionally or alternatively, in one or more embodiments, the processor 310 includes one or more processors configured in tandem via a bus to enable independent execution of instructions, pipelining of data, and/or multi-thread execution of instructions.

The memory 312 is non-transitory and includes, for example, one or more volatile memories and/or one or more non-volatile memories. In other words, in one or more embodiments, the memory 312 is an electronic storage device (e.g., a computer-readable storage medium). The memory 312 is configured to store information, data, content, one or more applications, one or more instructions, or the like, to enable the data optimization computer system 302 to carry out various functions in accordance with one or more embodiments disclosed herein. As used herein in this disclosure, the term “component,” “system,” and the like, is a computer-related entity. For instance, “a component,” “a system,” and the like disclosed herein is either hardware, software, or a combination of hardware and software. As an example, a component is, but is not limited to, a process executed on a processor, a processor, circuitry, an executable component, a thread of instructions, a program, and/or a computer entity.

In an embodiment, the data optimization computer system 302 (e.g., the data mapping component 304 of the data optimization computer system 302) receives disparate data 314. In one or more embodiments, the data optimization computer system 302 (e.g., the data mapping component 304 of the data optimization computer system 302) receives the disparate data 314 from one or more data sources 316. In certain embodiments, at least one data source from the one or more data sources 316 incorporates encryption capabilities to facilitate encryption of one or more portions of the disparate data 314. In certain embodiments, the one or more data sources 316 are one or more IT data sources. Additionally, in one or more embodiments, the data optimization computer system 302 (e.g., the data mapping component 304 of the data optimization computer system 302) receives the disparate data 314 via the network 110. In one or more embodiments, the network 110 is a Wi-Fi network, a Near Field Communications (NFC) network, a Worldwide Interoperability for Microwave Access (WiMAX) network, a personal area network (PAN), a short-range wireless network (e.g., a Bluetooth® network), an infrared wireless (e.g., IrDA) network, an ultra-wideband (UWB) network, an induction wireless transmission network, and/or another type of network. In one or more embodiments, the one or more data sources 316 are associated with components of the edge 115 such as, for example, one or more enterprises 160a-160n. In one or more embodiments, the one or more data sources 316 are similar but ununified data sources. For example, in an embodiment, the one or more data sources 316 are procurement data sources in different subsidiaries of an enterprise system (e.g., procurement systems and finance systems, sales systems and procurement systems, etc.).

The disparate data 314 includes, for example, unclassified data, unclassified data elements, unclassified data entities, and/or other unclassified information. In certain embodiments, the disparate data 314 additionally includes classified data (e.g., previously classified data). Furthermore, in one or more embodiments, the disparate data 314 includes one or more data fields (e.g., one or more fillable fields). In one or more embodiments, a data field associated with the disparate data 314 may include, may be formatted with, and/or may be tagged with a data element. Alternatively, in one or more embodiments, a data field associated with the disparate data 314 may be an incomplete data field that is formatted without a data element. In one or more embodiments, the disparate data 314 includes transaction data (e.g., unclassified transaction data), purchase record data (e.g., unclassified purchase record data), invoice data (e.g., unclassified invoice data), purchase order data (e.g., unclassified purchase order data), supplier data (e.g., unclassified supplier data), contract data (e.g., unclassified contract data), process data (e.g., unclassified process data), industrial data (unclassified industrial data), asset data (e.g., unclassified asset data), shipping data (e.g., unclassified shipping data), sensor data (e.g., unclassified sensor data), location data (e.g., unclassified location data), user data (e.g., unclassified purchase record data), and/or other data (e.g., other unclassified data). In an example, at least a portion of the disparate data 314 includes data associated with one or more dynamically modifiable electronic purchase agreements. In another example, at least a portion of the invoice data associated with the disparate data 314 includes a purchase order number, an invoice number, a supplier identifier, a payment term, an invoice amount, a supplier hierarchy level identifier, and/or other invoice information. In another example, at least a portion of the purchase data associated with the disparate data 314 includes a purchase order number, a supplier identifier, a purchase order line item, a purchase order remaining value, a purchase order term, a part number, a product commodity family, a part description, and/or other purchase order information.

In one or more embodiments, the data mapping component 304 aggregates the disparate data 314 from the one or more data sources 316. For instance, in one or more embodiments, the data mapping component 304 can aggregate the disparate data 314 into a data lake 318. In one or more embodiments, the data lake 318 is a centralized repository (e.g., a single data lake) that stores unstructured data and/or structured data included in the disparate data 314. In one or more embodiments, the data mapping component 304 repeatedly updates data of the data lake 318 at one or more predetermined intervals. For instance, in one or more embodiments, the data mapping component 304 stores new data and/or modified data associated with the one or more data sources 316. In one or more embodiments, the data mapping component 304 repeatedly scans the one or more data sources 316 to determine new data for storage in the data lake 318.

In one or more embodiments, the data mapping component 304 formats one or more portions of the disparate data 314. For instance, in one or more embodiments, the data mapping component 304 provides a formatted version of the disparate data 314. In an embodiment, the formatted version of the disparate data 314 is formatted with one or more defined formats. A defined format is, for example, a structure for data fields. In one embodiment, a defined format is predetermined. For example, in one or more embodiments, a predominant type of structure (e.g., a predominant type of format, predominant type of procurement form, etc.) may be employed as a template for future use. In another embodiment, the defined format is determined based on analysis of the disparate data 314 (e.g., in response to a majority of the disparate data 314 being received). In various embodiments, the formatted version of the disparate data 314 is stored in the data lake 318.

In one or more embodiments, the data mapping component 304 identifies one or more different data fields in the disparate data 314 that describe a corresponding subject. For example, in one or more embodiments, the data mapping component 304 identifies one or more different data fields in the disparate data 314 that describe a corresponding vendor name. In another example, the mapping component 304 identifies one or more different data fields in the disparate data 314 that describe corresponding payment terms. In one or more embodiments, the data mapping component 304 determines one or more incomplete data fields of the disparate data 314 that corresponds to the identified one or more different data fields. In accordance with a determination that the one or more determined incomplete data fields correspond to the identified one or more different data fields, in one or more embodiments, the data mapping component 304 adds data from an identified data field to an incomplete data field of the disparate data 314. In one or more embodiments, the data mapping component 304 assigns one or more tags and/or metadata to the disparate data 314. In one or more embodiments, the data mapping component 304 extracts data from the disparate data 314 using one or more natural language processing techniques. In one or more embodiments, the data mapping component 304 determines one or more data elements, one or more words, and/or one or more phrases associated with the disparate data 314. In one or more embodiments, the data mapping component 304 predicts data for a data field based on a particular intent associated with different data elements, words, and/or phrases associated with the disparate data 314. For example, in an embodiment, the data mapping component 304 predicts data for a first data field associated with transaction data based on a particular intent associated with different data elements, words, and/or phrases associated with other transaction data stored in the disparate data 314. In another example related to another embodiment, the data mapping component 304 predicts data for a first data field associated with industrial data based on a particular intent associated with different data elements, words, and/or phrases associated with other industrial data stored in the disparate data 314. In one or more embodiments, the data mapping component 304 identifies and/or groups data types associated with the disparate data 314 based on a hierarchical data format. In one or more embodiments, the data mapping component 304 employs batching, concatenation of data columns, identification of data types, merging of data, reading of data and/or writing of data to facilitate data mapping associated with the disparate data 314. In one or more embodiments, the data mapping component 304 performs feature processing to remove one or more defined characters (e.g., special characters), tokenize one or more strings of characters, remove one or more defined words (e.g., one or more stop words), remove one or more single character tokens, and/or other feature processing with respect to the disparate data 314. In one or more embodiments, the data mapping component 304 groups data from the disparate data 314 based on corresponding features of the data. In one or more embodiments, the data mapping component 304 groups data from the disparate data 314 based on corresponding identifiers (e.g., a matching part commodity family) for the data. In one or more embodiments, the data mapping component 304 employs one or more locality-sensitive hashing techniques to group data from the disparate data 314 based on similarity scores and/or calculated distances between different data in the disparate data 314.

In one or more embodiments, the data mapping component 304 organizes the formatted version of the disparate data 314 based on an ontological tree structure. For instance, in one or more embodiments, the data mapping component 304 employs a hierarchical data format technique to organize the formatted version of the disparate data 314 in the ontological tree structure. In an embodiment, the ontological tree structure captures relationships among different data within the disparate data 314 based on a hierarchy of nodes and connections among the different data within the disparate data 314. In an embodiment, a node of the ontological tree structure corresponds to a data element and a connection of the ontological tree structure represents a relationship between nodes (e.g., data elements) of the ontological tree structure. In one or more embodiments, the data mapping component 304 traverses the ontological tree structure to traverse associating aspects of the disparate data 314. In one or more embodiments, the data mapping component 304 compares different data sources of the one or more data sources 316 and/or data from different data sources of the one or more data sources 316 based on the ontological tree structure.

In one or more embodiments, the data mapping component 304 generates one or more features associated with a format structure for the disparate data 314. For instance, in one or more embodiments, the data mapping component 304 generates one or more features associated with one or more defined formats for the format structure. The format structure is, for example, a target format structure for the disparate data 314. In one or more embodiments, the format structure is a format structure for one or more portions of the data lake 318. In an embodiment, the one or more features include one or more data field features for the format structure. For example, in an embodiment, the one or more features include one or more column name features for the format structure. Additionally or alternatively, in an embodiment, the one or more features include one or more column value features for the format structure. However, it is to be appreciated that the one or more features can additionally or alternatively include one or more other types of features associated with the format structure. In certain embodiments, the one or more features generated by the data mapping component 304 include one or more text embeddings for column names associated with the format structure. For example, in certain embodiments, the one or more features generated by the data mapping component 304 include one or more text embeddings for column names associated with a source column name and/or a target column name for one or more portions of the disparate data 314. Additionally or alternatively, in certain embodiments, the one or more features generated by the data mapping component 304 include one or more text embeddings for column values associated with the format structure. In certain embodiments, the data mapping component 304 learns one or more vector representations of the one or more text embeddings associated with the column names and/or column values.

The data mapping component 304 generates the one or more features associated with the format structure for the disparate data 314 based on one or more feature generation techniques. In an embodiment, the data mapping component 304 generates the one or more features associated with the format structure for the disparate data 314 based on a classifier trained based on TF-IDF and/or n-gram features associated with natural language processing where respective portions of the disparate data 314 is converted into a numerical format represented by a matrix. In another embodiment, the data mapping component 304 generates the one or more features associated with the format structure for the disparate data 314 based on SIF where sentence embeddings are computing using word vector averaging of one or more portions of the disparate data 314. In another embodiment, the data mapping component 304 generates the one or more features associated with the format structure for the disparate data 314 based on a universal sentence encoder that encodes one or more portions of the disparate data 314 into dimensional vectors to facilitate text classification and/or other natural language processing associated with the one or more portions of the disparate data 314. In another embodiment, the data mapping component 304 generates the one or more features associated with the format structure for the disparate data 314 based on a BERT embedding technique that employs tokens associated with classification tasks to facilitate text classification and/or other natural language processing associated with the one or more portions of the disparate data 314. Additionally or alternatively, the data mapping component 304 generates the one or more features associated with the format structure for the disparate data 314 based on a library of learned word embeddings and/or text classifications associated with natural language processing. In certain embodiments, the data mapping component 304 generates the one or more features based on vocabulary ground truth data associated with one or more templates. For instance, in one or more embodiments, the data mapping component 304 generates vocabulary ground truth data for the format structure based on one or more templates associated with historical disparate data. Furthermore, based on the vocabulary ground truth data associated with the historical disparate data, the data mapping component 304 generates the one or more features.

In one or more embodiments, the data mapping component 304 maps, based on the one or more features, respective portions of the disparate data 314 to provide the formatted version of disparate data 314. In an embodiment, the data mapping component 304 maps the respective portions of the disparate data 314 based on the one or more text embeddings associated with the column names for the format structure. Additionally, in one or more embodiments, the data mapping component 304 maps the respective portions of the disparate data 314 based on decision tree classification associated with the column names for the format structure. In certain embodiments, the data mapping component 304 calculates one or more similarity scores between one or more source column names and one or more defined target column names to facilitate mapping respective portions of the disparate data 314 to provide the formatted version of disparate data 314. In certain embodiments, the data mapping component 304 maps the respective portions of the disparate data 314 based on a set of transformer encoder layers associated with a neural network. Additionally or alternatively, in certain embodiments, the data mapping component 304 maps the respective portions of the disparate data 314 based on a text classifier associated with a neural network.

In certain embodiments, the data mapping component 304 employs one or more column values to map a source column name to a target column name. For example, in certain embodiments, the data mapping component 304 employs a list of column values of source columns to predict target column mappings for one or more portions of the disparate data. In an example, the data mapping component 304 employs a source column value of “280460-HSPL-3493664-280460” to map a source column name “kunnr” to a target column name “sold_to_customer_number.” In another example, the data mapping component 304 employs a source column value of “MMS-AUTOMATIC DETECTION” to map a source column name “prctr” to a target column name “profit_center_name.” In another example, the data mapping component 304 employs a source column value of “ZMPN00000000019156” to map a source column name “matx” to a target column name “material_number.” In another example, the data mapping component 304 employs a source column value of “30303” to map a source column name “kunplz” to a target column name “sold_to_zip_code.”

In an embodiment, the artificial intelligence component 306 performs a deep learning process with respect to the formatted version of the disparate data 314. For instance, in one or more embodiments, the artificial intelligence component 306 performs a deep learning process with respect to the formatted version of the disparate data 314 determine one or more classifications, one or more inferences, and/or one or more insights associated with the disparate data 314. In certain embodiments, the deep learning process performed by the artificial intelligence component 306 employs regression analysis to determine one or more insights associated with the disparate data 314. In certain embodiments, the deep learning process performed by the artificial intelligence component 306 employs a clustering technique to determine one or more insights associated with the disparate data 314. In one or more embodiments, the artificial intelligence component 306 performs the deep learning process to determine one or more categories and/or one or more patterns associated with the disparate data 314. In one or more embodiments, the artificial intelligence component 306 employs a recurrent neural network to map the disparate data 314 into multi-dimensional word embeddings for the ontological tree structure. In an embodiment, a word embedding corresponds to a node of the ontological tree structure. In one or more embodiments, the artificial intelligence component 306 employs a network of gated-recurrent units of the recurrent neural network to provide one or more classifications, one or more inferences, and/or one or more insights associated with the disparate data 314.

In one or more embodiments, the data optimization computer system 302 (e.g., the action component 308 of the data optimization computer system 302) receives a request 320. In an embodiment, the request 320 is a request to obtain one or more insights with respect to the disparate data 314. In one or more embodiments, the request 320 includes an insight descriptor that describes a goal for the one or more insights. In one or more embodiments, the goal is a desired data analytics result and/or target associated with the disparate data 114. In an embodiment, the insight descriptor is a word or a phrase that describes the goal for the one or more insights. In another embodiment, the insight descriptor is an identifier that describes the goal for the one or more insights. In yet another embodiment, the insight descriptor is a subject that describes the goal for the one or more insights. However, it is to be appreciated that, in certain embodiments, the insight descriptor is another type of descriptor that describes the goal for the one or more insights. In one or more embodiments, the goal is an unclassified spend goal, a payment term optimization goal, an alternate supplier recommendation goal, and/or another insight goal. In various embodiments, the request 320 is generated by an electronic interface of a computing device. In an exemplary embodiment, the request 320 includes a request to obtain one or more insights with respect to unclassified spend for one or more assets and/or services associated with the disparate data 314. Additionally, in one or more embodiments, the artificial intelligence component 306 performs a deep learning process to provide one or more insights for unclassified spend related to the one or more assets and/or services. In another exemplary embodiment, the request 320 includes a request to obtain one or more insights with respect to payment term optimization for one or more assets and/or services associated with the disparate data 314. Additionally, in one or more embodiments, the artificial intelligence component 306 performs a deep learning process to provide one or more insights for payment term optimization related to the one or more assets and/or services. In another exemplary embodiment, the request 320 includes a request to obtain one or more insights with respect to an alternate supplier for one or more assets and/or services associated with the disparate data 314. Additionally, in one or more embodiments, the artificial intelligence component 306 performs a deep learning process to provide one or more insights for an alternate supplier related to the one or more assets and/or services.

In one or more embodiment, in response to the request 320, the action component 308 associates aspects of the formatted version of the disparate data 314 to provide the one or more insights. In an aspect, the action component 308 determines the associated aspects of the formatted version of the disparate data 314 based on the goal and/or relationships between aspects of the formatted version of the disparate data 314. Additionally, in one or more embodiments, the action component 308 performs one or more actions based on the one or more insights. For instance, in one or more embodiments, the action component 308 generates action data 322 associated with the one or more actions. In one or more embodiments, the action component 308 additionally employs a scoring model based on different metrics from historical iterations of the deep learning process and/or previous actions to determine the one or more actions. For example, in one or more embodiments, the scoring model employs weights for different metrics, different conditions, and/or different rules. In one or more embodiments, the action component 308 additionally employs location data (e.g., geographic area exceptions to modify a recommendation and/or to remove false positive recommendations based on one or more regulations associated with a geographic location. In one or more embodiments, the action component 308 additionally employs contract data to modify a recommendation and/or to remove false positive recommendations based on one or more contract terms. In one or more embodiments, the action component 308 additionally employs cost metrics (e.g., unit cost) related to one or more assets and/or services to modify a recommendation and/or to remove false positive recommendations for the one or more assets and/or services. In one or more embodiments, the action component 308 additionally employs risk metrics (e.g., supplier risk metrics) related to one or more assets and/or services to modify a recommendation and/or to remove false positive recommendations for the one or more assets and/or services. In a non-limiting example, the action component 308 determines that an alternate supplier for an asset and/or service is available based on a match between part numbers in different portions of the disparate data 314. In another non-limiting example, the action component 308 determines that an alternate supplier for an asset and/or service is available based on a match between part descriptions in different portions of the disparate data 314

In an embodiment, an action from the one or more actions includes generating a user-interactive electronic interface that renders a visual representation of the one or more insights. In another embodiment, an action from the one or more actions includes transmitting, to a computing device, one or more notifications associated with the one or more insights. In another embodiment, an action from the one or more actions includes retraining one or more portions of the recurrent neural network based on the one or more insights. In another embodiment, an action from the one or more actions includes determining one or more features associated with the one or more insights and/or predicting, based on the one or more features associated with the one or more insights, a condition for an asset associated with the disparate data 314. In another embodiment, an action from the one or more actions includes predicting, based on the one or more insights, a shipping condition for an asset associated with the disparate data 314. In another embodiment, an action from the one or more actions includes determining, based on the one or more insights, total spend for a part commodity family associated with the disparate data 314. In another embodiment, an action from the one or more actions includes determining, based on the one or more insights, one or more conditions for a contract related to an asset or service associated with the disparate data 314. In another embodiment, an action from the one or more actions includes determining, based on the one or more insights, one or more conditions for a transactional deal agreement related to an asset or service associated with the disparate data 314. In another embodiment, an action from the one or more actions includes optimizing, based on the one or more insights, a payment term related to an asset or service associated with the disparate data 314. In another embodiment, an action from the one or more actions includes determining, based on the one or more insights, a distribution of spend related to an asset or service associated with the disparate data 314. In another embodiment, an action from the one or more actions includes determining, based on the one or more insights, an alternate supplier for an asset or service associated with the disparate data 314. In another embodiment, an action from the one or more actions includes determining, based on the one or more insights, a supplier recommendation related to an asset or service associated with the disparate data 314. In another embodiment, an action from the one or more actions includes determining, based on the one or more insights, likelihood of success for a given scenario associated with the disparate data 314. In another embodiment, an action from the one or more actions includes providing an optimal process condition for an asset associated with the disparate data 314. For example, in another embodiment, an action from the one or more actions includes adjusting a set-point and/or a schedule for an asset associated with the disparate data 314. In another embodiment, an action from the one or more actions includes one or more corrective action to take for an asset associated with the disparate data 314. In another embodiment, an action from the one or more actions includes providing an optimal maintenance option for an asset associated with the disparate data 314. In another embodiment, an action from the one or more actions includes an action associated with the application services layer 225, the applications layer 230, and/or the core services layer 235. In certain embodiments, the data mapping component 304 updates one or more features based on a quality score associated with the one or more insights. Additionally or alternatively, in certain embodiments, the data mapping component 304 updates one or more features based on user feedback data associated with the one or more insights.

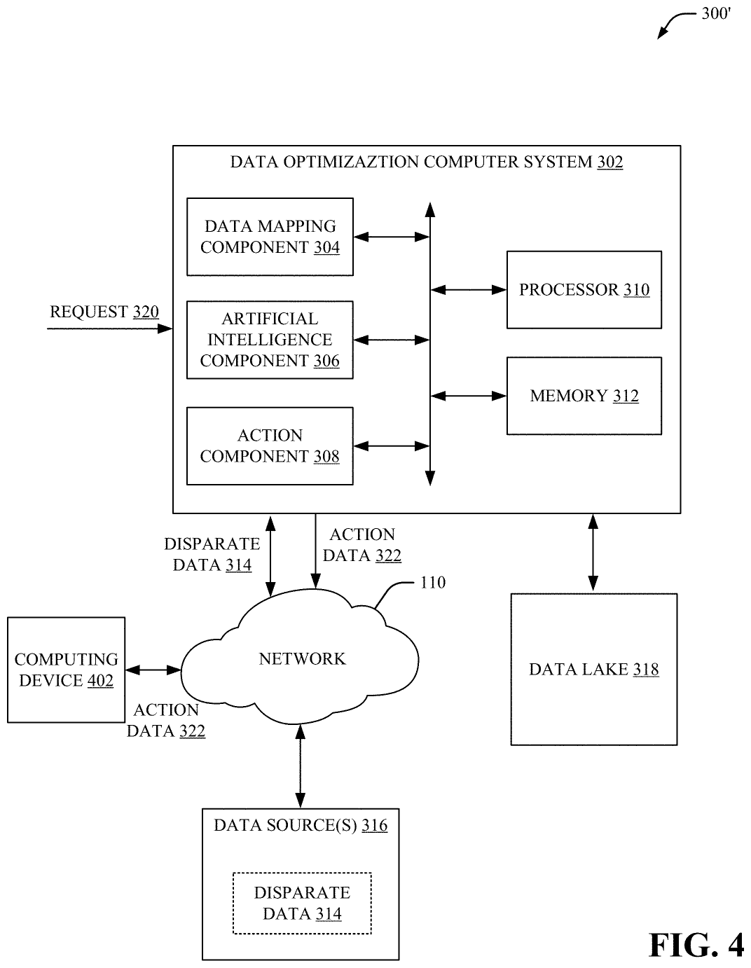

FIG. 4 illustrates a system 300′ that provides an exemplary environment according to one or more described features of one or more embodiments of the disclosure. In an embodiment, the system 300′ corresponds to an alternate embodiment of the system 300 shown in FIG. 3. According to an embodiment, the system 300′ includes the data optimization computer system 302, the one or more data sources 316, the data lake 318 and/or a computing device 402. In one or more embodiments, the data optimization computer system 302 is in communication with the one or more data sources 316 and/or the computing device 402 via the network 110. The computing device 402 is a mobile computing device, a smartphone, a tablet computer, a mobile computer, a desktop computer, a laptop computer, a workstation computer, a wearable device, a virtual reality device, an augmented reality device, or another type of computing device located remote from the data optimization computer system 302.

In one or more embodiments, the action component 308 communicates the action data 322 to the computing device 402. For example, in one or more embodiments, the action data 322 includes one or more visual elements for a visual display (e.g., a user-interactive electronic interface) of the computing device 402 that renders a visual representation of the one or more insights. In certain embodiments, the visual display of the computing device 402 displays one or more graphical elements associated with the action data 322 (e.g., the one or more insights). In certain embodiments, the visual display of the computing device 402 provides a graphical user interface to facilitate managing data use associated with one or more assets associated with the disparate data 314, costs associated with one or more assets associated with the disparate data 314, asset planning associated with one or more assets associated with the disparate data 314, asset services associated with one or more assets associated with the disparate data 314, asset operations associated with one or more assets associated with the disparate data 314, and/or one or more other aspects of one or more assets associated with the disparate data 314. In certain embodiments, the visual display of the computing device 402 provides a graphical user interface to facilitate predicting a shipping condition for one or more assets associated with the disparate data 314. In certain embodiments, the visual display of the computing device 402 provides a graphical user interface to facilitate predicting total spend for one or more assets associated with the disparate data 314. In another example, in one or more embodiments, the action data 322 includes one or notifications associated with the one or more insights. In one or more embodiments, the action data 322 allows a user associated with the computing device 402 to make decisions and/or perform one or more actions with respect to the one or more insights.

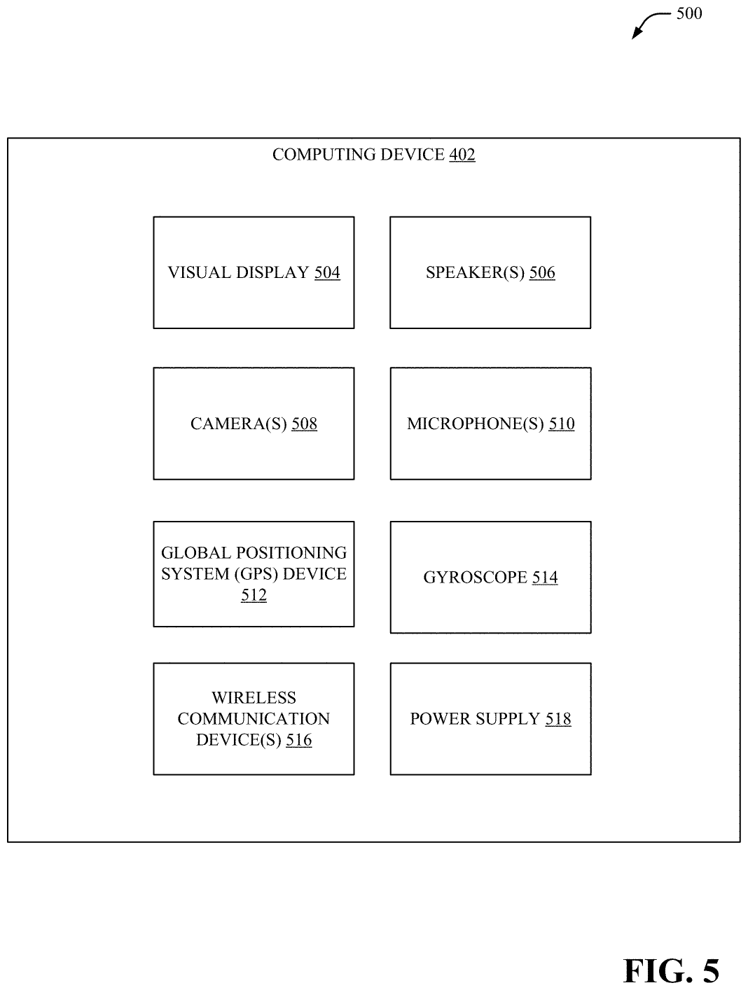

FIG. 5 illustrates a system 500 according to one or more embodiments of the disclosure. The system 500 includes the computing device 402. In one or more embodiments, the computing device 402 employs mobile computing, augmented reality, cloud-based computing, IoT technology and/or one or more other technologies to provide video, audio, real-time data, graphical data, one or more communications one or more messages, one or more notifications, one or more documents, one or more work procedures, industrial asset tag details, and/or other media data associated with the one or more insights. The computing device 402 includes mechanical components, electrical components, hardware components and/or software components to facilitate obtaining one or more insights associated with the disparate data 314. In the embodiment shown in FIG. 5, the computing device 402 includes a visual display 504, one or more speakers 506, one or more cameras 508, one or more microphones 510, a global positioning system (GPS) device 512, a gyroscope 514, one or more wireless communication devices 516, and/or a power supply 518.

In an embodiment, the visual display 504 is a display that facilitates presentation and/or interaction with one or more portions of the action data 322. In one or more embodiments, the computing device 402 displays an electronic interface (e.g., a graphical user interface) associated with a data analytics platform. In one or more embodiments, the visual display 504 is a visual display that renders one or more interactive media elements via a set of pixels. The one or more speakers 506 include one or more integrated speakers that project audio. The one or more cameras 508 include one or more cameras that employ autofocus and/or image stabilization for photo capture and/or real-time video. The one or more microphones 510 include one or more digital microphones that employ active noise cancellation to capture audio data. The GPS device 512 provides a geographic location for the computing device 402. The gyroscope 514 provides an orientation for the computing device 402. The one or more wireless communication devices 516 includes one or more hardware components to provide wireless communication via one or more wireless networking technologies and/or one or more short-wavelength wireless technologies. The power supply 518 is, for example, a power supply and/or a rechargeable battery that provides power to the visual display 504, the one or more speakers 506, the one or more cameras 508, the one or more microphones 510, the GPS device 512, the gyroscope 514, and/or the one or more wireless communication devices 516. In certain embodiments, data associated with the one or more insights is presented via the visual display 504 and/or the one or more speakers 506.

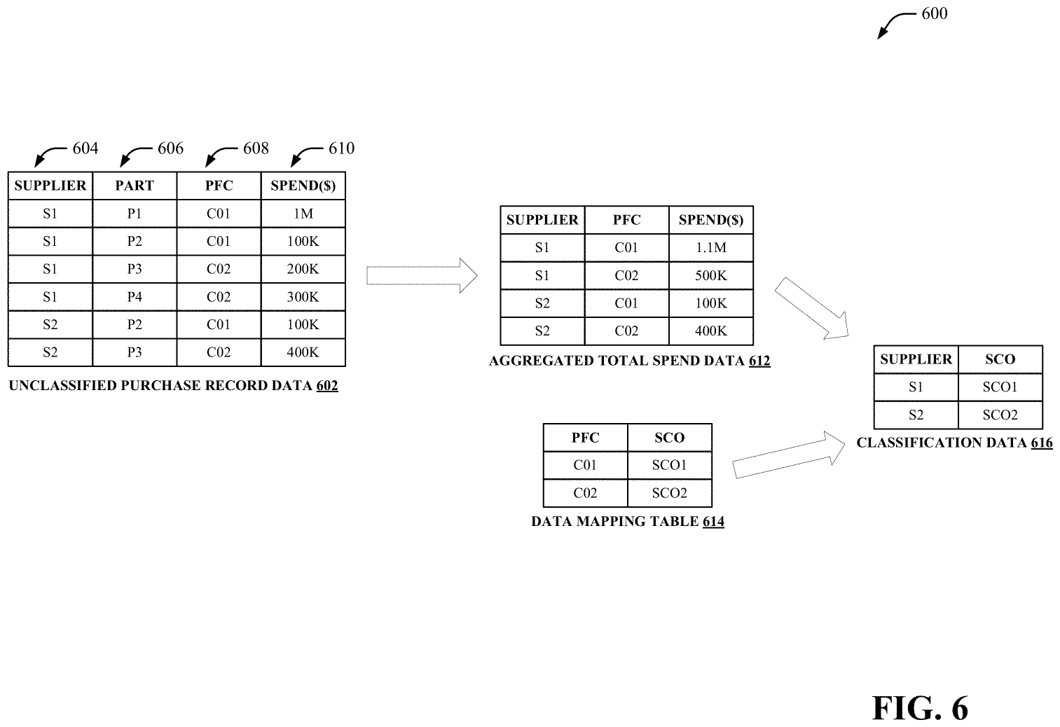

FIG. 6 illustrates a system 600 according to one or more described features of one or more embodiments of the disclosure. In an embodiment, the system 600 includes unclassified purchase record data 602. For instance, in an embodiment, the unclassified purchase record data 602 corresponds to at least a portion of the disparate data 314 obtained from the one or more data sources 316. It is to be appreciated that, in certain embodiments, the unclassified purchase record data 602 corresponds to other unclassified data such as other unclassified record data, unclassified asset data, unclassified industrial data, etc. In an example, the unclassified purchase record data 602 includes data fields 604 associated with supplier information, data fields 606 associated with part (e.g., asset) information, data fields 608 associated with a part family code (PFC), and/or data fields 610 associated with spend. However, it is to be appreciated that, in certain embodiments, the unclassified purchase record data 602 (e.g., data fields of the unclassified purchase record data) is associated with other information related to unclassified spend, payment term optimization, alternate supplier recommendation, and/or other insights goals. For example, in certain embodiments, the data fields 604 additionally or alternately includes one or more data fields related to a purchase order number, an invoice number, a supplier identifier, a payment term, an invoice amount, a supplier hierarchy level identifier, a purchase order line item, a purchase order remaining value, a purchase order term, a part number, a product commodity family, a part description, and/or other information. In an embodiment, the data mapping component 304 aggregates the unclassified purchase record data 602 to generate aggregated total spend data. For instance, in an embodiment, the data mapping component 304 aggregates the data fields 604 associated with supplier information, the data fields 606 associated with part (e.g., asset) information, the data fields 608 associated with PFC, and/or the data fields 610 associated with spend into total spend for each supplier and each PFC. In one or more embodiments, the action component 308 determines a PFC with a highest spend. For instance, as shown in FIG. 6, the PFC of a top spending supplier S1 is C01. In one or more embodiments, the data mapping component 304 and/or the artificial intelligence component 306 employs a data mapping table 614 that maps PFC to a supplier commodity office to determine classification data 616 for the aggregated total spend data 612. For example, in one or more embodiments, the data mapping table 614 is configured to provide a mapping between a data field (e.g., PFC) and a particular classification to determine classification data 616 for the aggregated total spend data 612. In one or more embodiments, the aggregated total spend data 612 is formatted as a vector of data or a data matrix and the data mapping table 614 is configured to provide alter dimensionality of the aggregated total spend data 612 into a different data dimensionality.

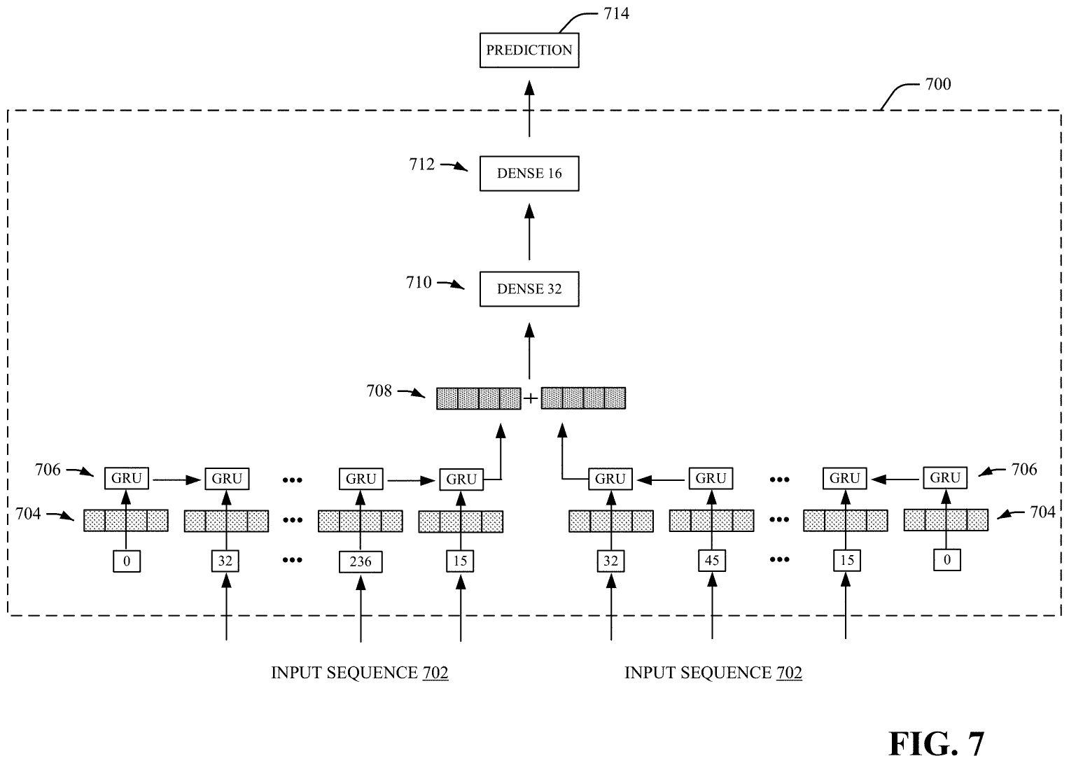

FIG. 7 illustrates a machine learning model 700 that according to one or more described features of one or more embodiments of the disclosure. In an embodiment, the machine learning model 700 is a recurrent neural network. In another embodiment, the machine learning model 700 is a convolutional neural network. In another embodiment, the machine learning model 700 is a deep learning network. However, it is to be appreciated that, in certain embodiments, the machine learning model 700 is another type of artificial neural network. In one or more embodiments, an input sequence 702 is provided as input to the machine learning model 700. In various embodiments, the input sequence 702 includes a set of data elements associated with the disparate data 314. In one or more embodiments, the data mapping component 304 employs the machine learning model 700 (e.g., the recurrent neural network) to map the input sequence 702 into multi-dimensional word embeddings 704. For example, in one or more embodiments, respective portions of the input sequence 702 are transformed into respective multi-dimensional word embeddings 704. In one or more embodiments, respective words associated with the input sequence 702 are mapped to respective vectors associated with the multi-dimensional word embeddings 704. In an embodiment, a multi-dimensional word embedding of the multi-dimensional word embeddings 704 is a vector of data or a matrix of data to facilitate one or more deep learning processes such as, for example, natural language processing. In one or more embodiments, the artificial intelligence component 306 provides the multi-dimensional word embeddings 704 to a network of gated-recurrent units 706. In an embodiment, a gated-recurrent unit (GRU) from the network of gated-recurrent units 706 is a gating mechanism with an update gate and/or a reset gate that determines data to pass through as output for the gated-recurrent unit. For instance, in an embodiment, an update gate determines an amount of the data that is passed along the network of gated-recurrent units 706 (e.g., how much previous data from a previous state of the network of gated-recurrent units 706 is provided to a next state of the network of gated-recurrent units 706) and the reset gate determines an amount of data that is withheld from being passed along the network of gated-recurrent units 706 (e.g., how much previous data is withheld from a next state of the network of gated-recurrent units 706). In one or more embodiments, output data from the network of gated-recurrent units 706 undergoes a concatenation process that combines data from respective gated-recurrent units of the network of gated-recurrent units 706. In certain embodiments, concatenated output 708 of the network of gated-recurrent units 706 is processed by a first dense layer 710 (e.g., a dense 32 layer) and/or a dense layer 712 (e.g., a dense 16 layer) that alters dimensionality of the concatenated output of the network of gated-recurrent units 706. Furthermore, based on the concatenated output of the network of gated-recurrent units 706, the dense layer 710 and/or the dense layer 716, the machine learning model 700 provides a prediction 714. In one or more embodiments, the prediction 714 is related to one or more insights with respect to the input sequence 702 (e.g., with respect to the set of data elements associated with the disparate data 314). For example, in one or more embodiments, the prediction 714 includes one or more classifications with respect to the input sequence 702 (e.g., with respect to the set of data elements associated with the disparate data 314). In an embodiment, the input sequence 702 includes one or more words from the disparate data 314 that is transformed into respective multi-dimensional word embeddings 704 associated with respective vectors of data. Respective GRUs from the network of gated-recurrent units 706 process the respective multi-dimensional word embeddings 704 to provide the concatenated output 708 that combines output from the respective GRUs from the network of gated-recurrent units 706. In certain embodiments, dimensionality of the concatenated output 708 is altered via the first dense layer 710 and/or the dense layer 712 to provide a predicted classification (e.g., the prediction 714) for the one or more words from the disparate data 314.

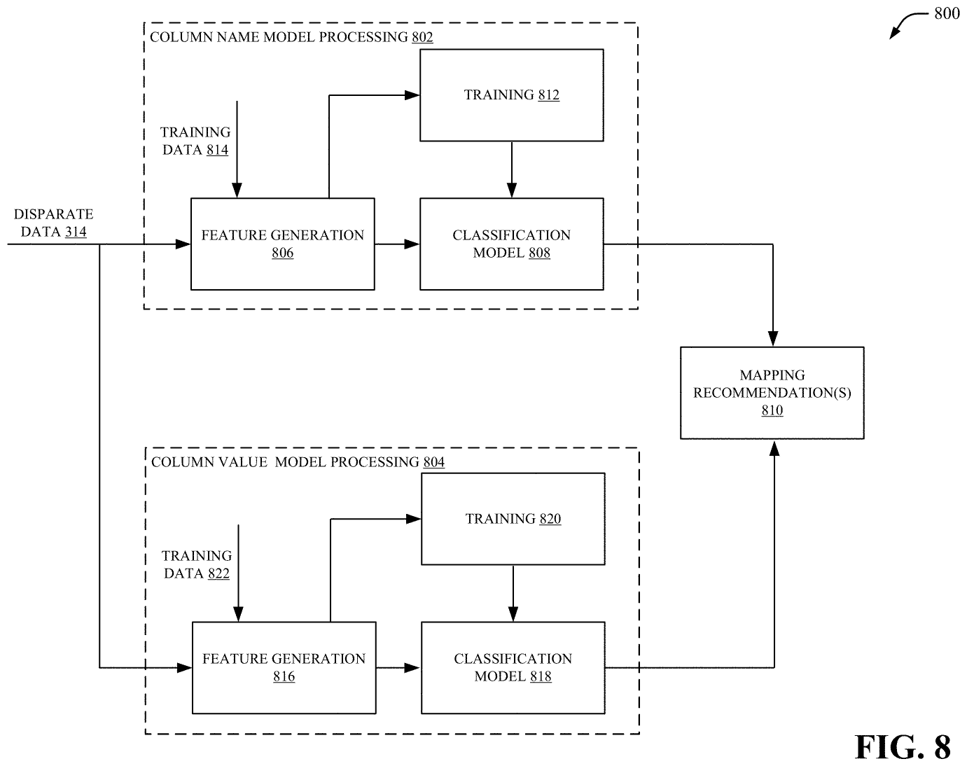

FIG. 8 illustrates a system 800 according to one or more embodiments of the disclosure. The system 800 provides, for example, a mapping model architecture. Furthermore, the system 800 illustrates one or more embodiments related to the data mapping component 304. In one or more embodiments, the disparate data 314 is processed by column name model processing 802 and/or column value model processing 804. The column name model processing 802 is employed to provide one or more column name features, classifications, and/or mapping recommendations associated with the format structure for one or more portions of the disparate data 314. In an embodiment, the column name model processing 802 includes feature generation 806. The feature generation 806 generates one or more column name features for the disparate data 314. For example, the feature generation 806 provides feature generation based on column names to provide input data (e.g., one or more column name features) for a classification model 808. In certain embodiments, the feature generation 806 generates the one or more column name features for the disparate data 314 based on a TF-IDF technique, a SIF technique, a universal sentence encoder technique, a BERT embedding technique, and/or another feature generation technique. In certain embodiments, the feature generation 806 generates the one or more column name features for the disparate data 314 based on a library of learned word embeddings and/or text classifications associated with natural language processing. The classification model 808 is, for example, a trained classification model that provides one or more inferences associated with the disparate data 314 and/or the one or more column name features for the disparate data 314. In an embodiment, the classification model 808 is a tree-based classification model. For example, in one or more embodiments, the classification model 808 is a hierarchical classification model that includes at least a first level associated with predicting a dataset category and a second level associated with predicting a corresponding column name using the predicted dataset category as a feature. Furthermore, in an embodiment, the classification model 808 generates at least a portion of one or more mapping recommendations 810. In certain embodiments, the column name model processing 802 includes training 812 that trains the classification model 808. In one or more embodiments, the training 812 trains the classification model 808 using one or more column name features generated based on training data 814. The training data 814 includes, for example, vocabulary ground truth data for the format structure that is generated based on one or more templates associated with historical column name features. In certain embodiments, the training data 814 includes predetermined target data associated with column name features.

The column value model processing 804 is employed to additionally or alternatively provide one or more column value features, classifications, and/or mapping recommendations associated with the format structure for one or more portions of the disparate data 314. In an embodiment, the column value model processing 804 includes feature generation 816. The feature generation 816 generates one or more column value features for the disparate data 314. For example, the feature generation 816 provides feature generation based on column values to provide input data (e.g., one or more column value features) for a classification model 818. The classification model 818 is, for example, a trained classification model that provides one or more inferences associated with the disparate data 314 and/or the one or more column value features for the disparate data 314. In an embodiment, the classification model 818 is a transformer-based classification model. For example, in one or more embodiments, the classification model 818 is a neural network that includes a set of transformer encoder layers, a set of hidden layers, a set of attention layers, and/or a dense layer. Furthermore, in an embodiment, the classification model 818 generates at least a portion of the one or more mapping recommendations 810. For example, in an embodiment, the classification model 818 provides a predicted target column mapping based on a set of column values associated with the disparate data 314. In certain embodiments, the column value model processing 804 includes training 820 that trains the classification model 818. In one or more embodiments, the training 820 trains the classification model 818 using one or more column value features generated based on training data 822. The training data 822 includes, for example, vocabulary ground truth data for the format structure that is generated based on one or more templates associated with historical column value features. In certain embodiments, the one or more mapping recommendations 810 is ranked based on respective confidence scores to provide a top-N number of mapping recommendations. In certain embodiments, the one or more mapping recommendations 810 is associated with a probability distribution of the mapping recommendations. In certain embodiments, the one or more mapping recommendations 810 are accepted by the data optimization computer system 302 and/or via user feedback associated with the computing device 402. In certain embodiments, the classification model 808 and/or the classification model 818 is retrained based on the one or more mapping recommendations 810. For example, in certain embodiments, the classification model 808 and/or the classification model 818 is retrained based on the one or more mapping recommendations 810 being accepted by the data optimization computer system 302. Additionally or alternatively, in certain embodiments, the classification model 808 and/or the classification model 818 is retrained based on the user feedback associated with the computing device 402.

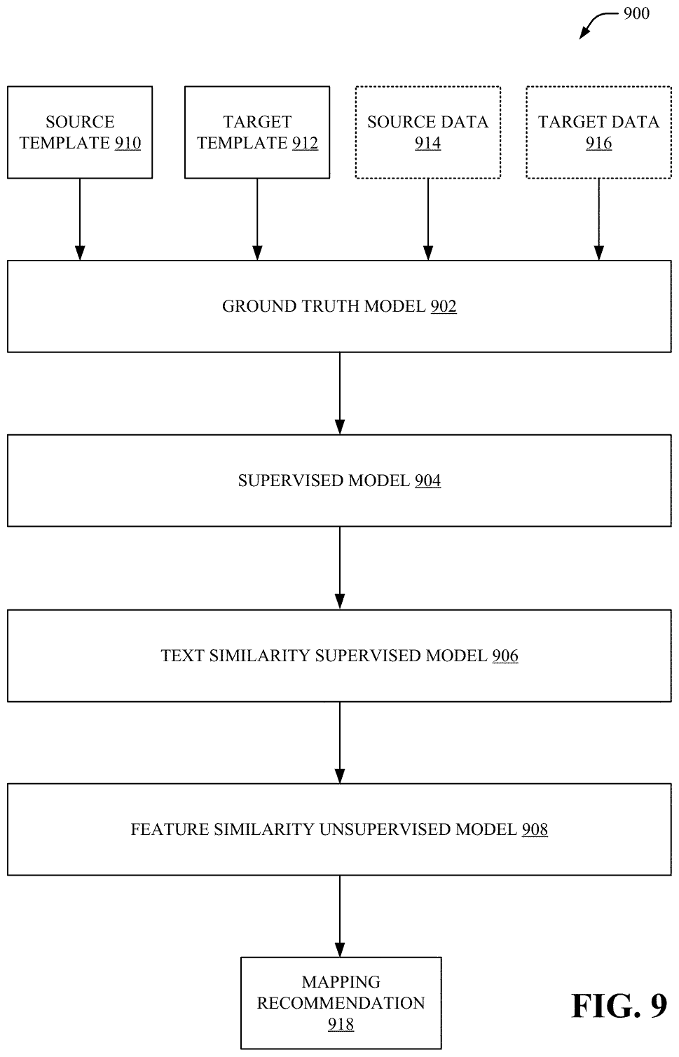

FIG. 9 illustrates a system 900 according to one or more embodiments of the disclosure. The system 900 provides, for example, a mapping model architecture. In one or more embodiments, the system 900 provides a column name model architecture related to the classification model 808. Furthermore, the system 900 illustrates one or more embodiments related to the data mapping component 304. The system 900 includes a ground truth model 902, a supervised model 904, a text similarity supervised mode 906 and/or a feature similarity unsupervised model 908. In one or more embodiments, a source template 910 and/or a target template 912 is provided as input to the ground truth model 902. The source template 910 is, for example, a template for a source format structure for one or more portions of the disparate data 314 associated with the one or more data sources 316. The target template 912 is, for example, a template for a target format structure for storage of the one or more portions of the disparate data 314 in the data lake 318. For example, in one or more embodiments, the source template 910 is associated with a set of source column names and the target template 912 is associated with a set of target column names. In certain embodiments, source data 914 and/or target data 916 is additionally or alternatively provided as input to the ground truth model 902. For example, in an embodiment the source data 914 is source data stored in the source template 910 and the target data 916 is historical target data stored in the target template 912. In one or more embodiments, one or more portions of the disparate data 314 corresponds to the source data 914.

In one or more embodiments, the ground truth model 902 employs the source template 910, the target template 912, the source data 914 and/or the target data 916 to generate vocabulary (e.g., vocabulary ground truth data) and/or features (e.g., feature ground truth data) for data field mapping related to a format structure. In one or more embodiments, the supervised model 904 is employed to predict a mapping for one or more data field mappings that do not satisfy a certain confidence threshold. For example, in one or more embodiments, the supervised model 904 predicts a mapping of source data fields for the source format structure with target data fields for the target format structure. In certain embodiments, the supervised model 904 is retrained based on at least a portion of the target data 916. In certain embodiments, at least a portion of the target data 916 is provided via the computing device 402.

In one or more embodiments, the text similarity supervised model 906 is employed to predict a mapping for one or more data field mappings that do not satisfy a certain confidence threshold. For instance, in certain embodiments, the text similarity supervised model 906 is employed to predict a mapping for one or more data field mappings that do not satisfy a certain confidence threshold following processing by the supervised model. In one or more embodiments, the text similarity supervised model 906 determines text similarity between data field names and/or data field descriptions of the target format structure and the source format structure. In an example embodiment, a target data field name is “BRGEW” and a data field description is “Weight.” As such, in an example, the text similarity supervised model 906 determines that the data field description “Weight” corresponds to “unit weight of a material.” In another example, the text similarity supervised model 906 determines that the data field description “Weight” corresponds to “material weight.” In another example, the text similarity supervised model 904 determines that the data field description “Weight” corresponds to a “Weight” data field description for a certain target format structure.

In one or more embodiments, the feature similarity supervised model 908 is employed to predict a mapping for one or more data field mappings that do not satisfy a certain confidence threshold. For instance, in certain embodiments, the feature similarity supervised model 908 is employed to predict a mapping for one or more data field mappings that do not satisfy a certain confidence threshold following processing by the supervised model and/or the text similarity supervised model. In one or more embodiments, the feature similarity supervised model 908 is configured to analyze and/or identity data characteristics related to the source data 914. Additionally or alternatively, in one or more embodiments, the feature similarity supervised model 908 determines feature matrix similarity between the source data 914 and the target data 916. In one or more embodiments, the feature similarity supervised model 908 provides a mapping recommendation 918. The mapping recommendation 918 is, for example, at least a portion of the one or more mapping recommendations 810. In an embodiment, the mapping recommendation 918 includes one or more mapping recommendations for the source data 914 (e.g., mapping recommendation for one or more portions of the disparate data 314). In another embodiment, the mapping recommendation 918 includes a predicted column name data field of a format structure for the source data 914 (e.g., one or more portions of the disparate data 314). In certain embodiments, the mapping recommendation 918 provides a formatted version of the source data 914 (e.g., one or more portions of the disparate data 314). In certain embodiments, the mapping recommendation 918 classifies one or more portions of the source data 914 as respective predefined column name labels.

In one or more embodiments, the ground truth model 902 maps context vocabulary generated from historical data. In certain embodiments, the historical data is associated with data objects such as “Customer Master,” “Vendor Master,” “Material Master,” “Bill of Materials,” “Routing,” “Purchasing Information Records,” and/or other data objects. In one or more embodiments, to enhance the ground truth model 902, valid tokens and/or invalid tokens are defined using historical mapping information and/or by analyzing trained model results. In one or more embodiments, valid tokens are used to recommend possible similar mappings for a field. In one or more embodiments, invalid tokens are used to eliminate model recommendations that show the same data characteristics or similar data characteristics. In one or more embodiments, the eliminated model recommendations are also deemed to not be related. The supervised model 904 is configured to perform mapping based on field names. In one or more embodiments, the supervised model 904 employs one or more natural language processing techniques to learn one or more patterns associated with the field names. The text similarity supervised model 906 is configured to perform mapping based on field descriptions. In one or more embodiments, the text similarity supervised model 906 performs a similarity check between field descriptions for systems, databases, and/or data models. For instance, in one or more embodiments, the text similarity supervised model 906 is employed to identify mapping similarity between field descriptions for systems, databases, and/or data models. In certain embodiments, the text similarity supervised model 906 executes two or more text similarity models to identify mapping similarity between field descriptions for systems, databases, and/or data models. In certain embodiments, an optimal recommendation associated with the two or more text similarity models is selected.

The feature similarity unsupervised model 908 is configured to perform mapping based on data features. In one or more embodiments, the feature similarity unsupervised model 908 analyses data to learn mappings between the systems, databases, and/or data models. In one or more embodiments, the feature similarity unsupervised model 908 compares features associated with the data using one or more similarity algorithm. In one or more embodiments, the feature similarity unsupervised model 908 segregates features based on datatype such as numeric features, character features, date features, and/or another datatype. Examples of numeric features include, but are not limited to, mean, median, standard deviation, skewness, and/or another numeric feature. Examples of character features include statistics based on whitespace, numeric, character, bracket, special character, and/or other features. In one or more embodiments, the feature similarity unsupervised model 908 determines custom features by searching for one or more specific patterns in the data and/or by identifying keywords for one or more of the data fields. In one or more embodiments, the feature similarity unsupervised model 908 clusters data fields into unique categories to reduce a size of a search space for data. As such, in one or more embodiments, an amount of time and/or an amount of computing resources for performing a feature comparison process is reduced.

In an embodiment, the source template 910 is a first template that includes a first template format configured with a first dimensionality associated with a first set of columns and/or column names. Furthermore, the target template 912 is a second template that includes a second template format configured with a second dimensionality associated with a second set of columns and/or column names. In one or more embodiments, the source data 914 includes asset data (e.g., asset data associated with edge devices 161a-n) stored in the source template 910 and the target data 916 is historical asset data stored in the target template 912. In one or more embodiments, the ground truth model 902 generates vocabulary (e.g., vocabulary ground truth data) and/or features (e.g., feature ground truth data) for the asset data associated with the source data 914 and the historical asset data associated with the target data 916. The vocabulary and/or features for the asset data associated with the source data 914 and/or the historical asset data associated with the target data 916 includes, for example, asset name, asset state, real-time asset values, target values, field status values, criticality indicators, one or more asset rules, one or more asset requirements, text embeddings, etc. Additionally, in one or more embodiments, the supervised model 904 predicts a mapping of source data fields for the source template 910 with target data fields for the target template 912. In one or more embodiments, the text similarity supervised model 906 determines text similarity between data field names and/or data field descriptions of the target format structure 910 and the source format structure 912. For example, in an embodiment, the text similarity supervised model 906 determines that the data field description “field status” in the source format structure 912 corresponds to “asset state” in the target format structure 910. In one or more embodiments, the feature similarity supervised model 908 is configured to analyze and/or identity data characteristics related to the asset data associated with the source data 914 and/or the historical asset data associated with the target data 916. In one or more embodiments, the mapping recommendation 918 provides a predicted column name data field of a format structure in the target template 912 for the source data 914 associated with the asset data.

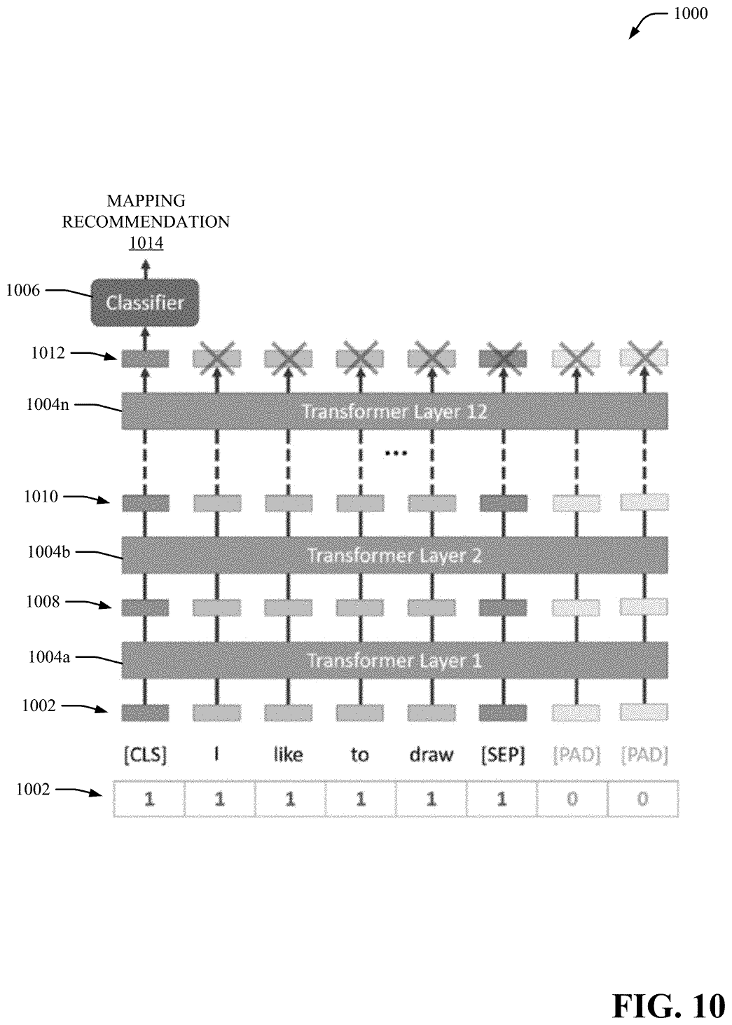

FIG. 10 illustrates a system 1000 according to one or more embodiments of the disclosure. In an embodiment, the system 1000 corresponds to a transformer-based classification model. In one or more embodiments, the system 1000 provides a column value model architecture related to the classification model 818. Furthermore, the system 1000 illustrates one or more embodiments related to the data mapping component 304. In one or more embodiments, input data 1002 is provided to a set of transformer layers 1004a-n of the system 1000. The input data 1002 corresponds to one or more portions of the disparate data 314. In one or more embodiments, the input data 1002 includes, for example, one or more column values associated with the disparate data 314. In one or more embodiments, the set of transformer layers 1004a-n learns one or more relationships and/or one or more features between the input data 1002. Respectively transformer layers from the set of transformer layers 1004a-n comprise respective weights and/or respective biases to facilitate learning one or more relationships and/or one or more features between the input data 1002. For example, in one or more embodiments, the set of transformer layers 1004a-n learns one or more relationships and/or one or more features between characters included in the input data 1002. In an embodiment, a transformer layer 1004a provides data 1008 associated with first learned relationships and/or features associated with the input data 1002. Furthermore, a transformer layer 1004b learns one or more relationships and/or one or more features associated with the data 1008 to provide data 1010 associated with second learned relationships and/or features. In the embodiment, a transformer layer 1004n also learns one or more relationships and/or one or more features to provide transformer layer output 1012 associated with n learned relationship and/or features, where n is an integer. The transformer layer output 1012 is provided as input to the classifier 1006 and the classifier 1006 employs the transformer layer output 1012 to provide a mapping recommendation 1014. The mapping recommendation 1014 is, for example, at least a portion of the one or more mapping recommendations 810. In an embodiment, the mapping recommendation 1014 includes one or more mapping recommendations for the input data 1002 (e.g., mapping recommendation for one or more portions of the disparate data 314). In another embodiment, the mapping recommendation 1014 includes a predicted column name data field of a format structure for the input data 1002 (e.g., one or more portions of the disparate data 314). In certain embodiments, the mapping recommendation 1014 provides a formatted version of the input data 1002 (e.g., one or more portions of the disparate data 314). In certain embodiments, the mapping recommendation 1014 classifies one or more portions of the input data 1002 as respective predefined column name labels.

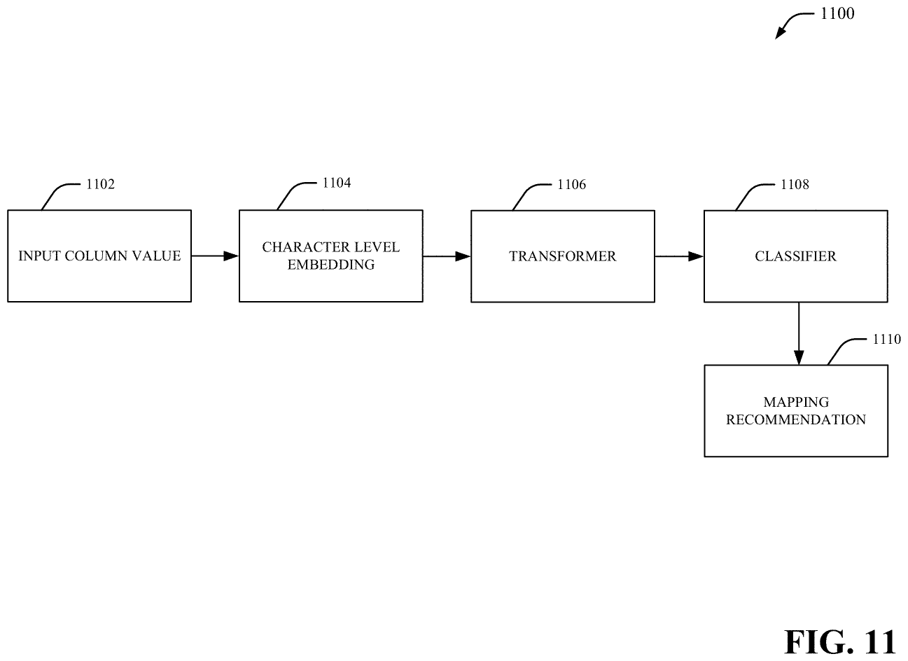

FIG. 11 illustrates a system 1100 according to one or more embodiments of the disclosure. In an embodiment, the system 1100 corresponds to a neural network architecture related to the classification model 818. Furthermore, the system 1000 illustrates one or more embodiments related to the data mapping component 304. In one or more embodiments, an input column value 1102 undergoes character level embedding 1104. The input column value 1102 corresponds, for example, to at least a portion of the disparate data 314. Additionally, in one or more embodiments, output of the character level embedding 1104 is provided to a transformer 1106 that provides transformer layer output to a classifier 1108. In certain embodiments, the transformer 1106 corresponds to the set of transformer layers 1004a-n and the classifier corresponds to the classifier 1006. The classifier 1108 provides a mapping recommendation 1110. The mapping recommendation 1110 is, for example, at least a portion of the one or more mapping recommendations 810. In an embodiment, the mapping recommendation 1110 includes one or more mapping recommendations for the input column value 1102. In another embodiment, the mapping recommendation 1110 includes a predicted column name data field of a format structure for the input column value 1102. In certain embodiments, the mapping recommendation 1110 provides a formatted version of the input column value 1102. In certain embodiments, the mapping recommendation 1110 classifies the input column value 1102 with a predefined column name label.

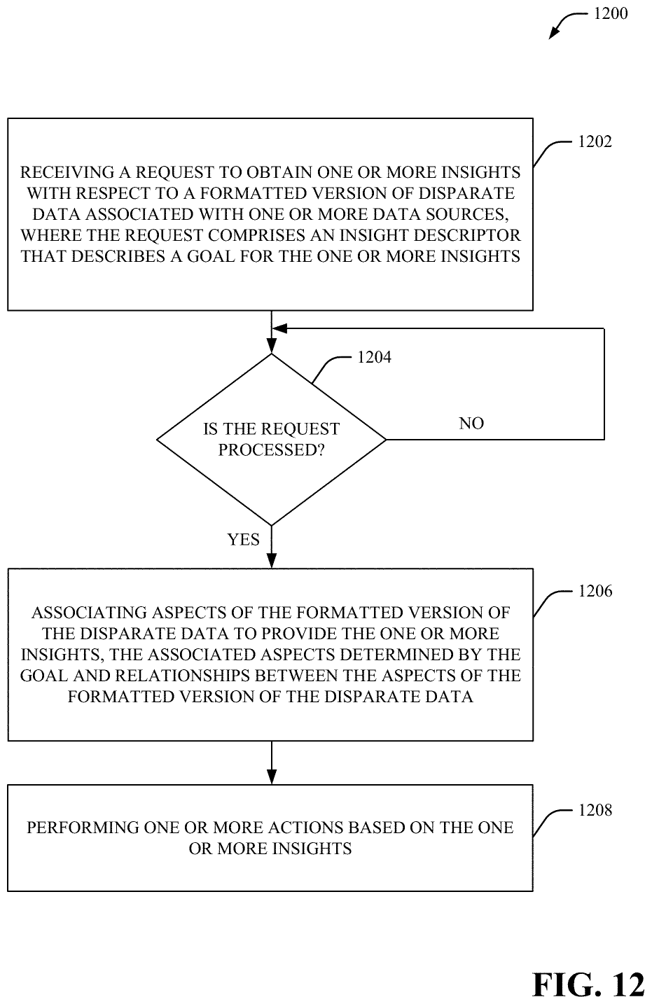

FIG. 12 illustrates a method 1200 for providing optimization related to enterprise performance management, in accordance with one or more embodiments described herein. The method 1200 is associated with the data optimization computer system 302, for example. For instance, in one or more embodiments, the method 1200 is executed at a device (e.g. the data optimization computer system 302) with one or more processors and a memory. In one or more embodiments, the method 1200 begins at block 1202 that receives (e.g., by the data mapping component 304) a request to obtain one or more insights with respect to a formatted version of disparate data associated with one or more data sources, where the request comprises an insight descriptor that describes a goal for the one or more insights (block 1202). The request to obtain the obtain one or more insights provides one or more technical improvements such as, but not limited to, facilitating interaction with a computing device, extended functionality for a computing device and/or improving accuracy of data provided to a computing device.

At block 1204, it is determined whether the request is processed. If no, block 1204 is repeated to determine whether the request is processed. If yes, the method 1200 proceeds to block 1206. In response to the request, block 1206 associates (e.g., by the artificial intelligence component 306) aspects of the formatted version of the disparate data to provide the one or more insights, the associated aspects determined by the goal and relationships between the aspects of the formatted version of the disparate data. The associating aspects of the formatted version of the disparate data provides one or more technical improvements such as, but not limited to, extended functionality for a computing device and/or improving accuracy of data provided to a computing device. In one or more embodiments, the associating the aspects of the formatted version of the disparate data includes correlating the aspects of the formatted version of the disparate data to provide the one or more insights. In one or more embodiments, the correlating the aspects of the formatted version of the disparate data includes employing machine learning associated with a machine learning model, a ground truth model, a supervised model, a text similarity supervised model, a feature similarity unsupervised model, column name model processing, column value model processing, a classifier, and/or another type of machine learning technique.

The method 1200 also includes a block 1208 that performs (e.g., by the action component 308) one or more actions based on the one or more insights. The performing the one or more actions provides one or more technical improvements such as, but not limited to, providing a varied experience for a computing device and/or providing visual indicators via a computing device. In one or more embodiments, the one or more actions includes generating user-interactive electronic interface that renders a visual representation of the one or more insights. In one or more embodiments, the one or more actions includes transmitting, to a computing device, one or more notifications associated with the one or more insights. In one or more embodiments, the one or more actions includes predicting, based on the one or more insights, a shipping condition for an asset associated with the disparate data. In one or more embodiments, the one or more actions includes determining, based on the one or more insights, a part commodity family for unclassified purchase record data associated with the disparate data. In one or more embodiments, the one or more actions includes determining, based on the one or more insights, total spend for a part commodity family.

In one or more embodiments, the method 1200 further includes aggregating the disparate data from the one or more data sources. The aggregating the disparate data from the one or more data sources provides one or more technical improvements such as, but not limited to, extended functionality for a computing device and/or improving accuracy of data provided to a computing device. In one or more embodiments, the aggregating the disparate data includes storing the disparate data in a single data lake and/or updating data of the single data lake at one or more predetermined intervals.

In one or more embodiments, the method 1200 further includes formatting one or more portions of the disparate data, the formatting providing the formatted version of the disparate data associated with a defined format. The formatting the one or more portions of the disparate data also provides one or more technical improvements such as, but not limited to, extended functionality for a computing device and/or improving accuracy of data provided to a computing device. In one or more embodiments, the method 1200 further includes determining one or more mapping recommendations for the formatted version of the disparate data. In one or more embodiments, the formatting the one or more portions of the disparate data includes identifying one or more different data fields in the disparate data from the one or more data sources, the different data fields describing a corresponding subject. Additionally, in one or more embodiments, the formatting the one or more portions of the disparate data includes determining one or more incomplete data fields from the one or more data sources, the one or more incomplete data fields corresponding to the identified one or more different data fields. In one or more embodiments, the formatting the one or more portions of the disparate data additionally includes in accordance with a determination that the one or more determined incomplete data fields from the one or more data sources correspond to the identified one or more different data fields, adding data from an identified data field to an incomplete data field. In one or more embodiments, the formatting the one or more portions of the disparate data includes organizing the formatted version of the disparate data based on an ontological tree structure, the ontological tree structure capturing relationships among different data within the disparate data. In one or more embodiments, the method 1200 further includes comparing different data sources based on the ontological tree structure. In one or more embodiments, the associating the aspect of the formatted version of the disparate data includes traversing the ontological tree structure, the traversing associating aspects of the disparate data. The ontological tree structure provides one or more technical improvements such as, but not limited to, extended functionality for a computing device, improving accuracy of data provided to a computing device, and/or improving efficiency of a computing device.

In one or more embodiments, the method 1200 further includes performing a deep learning process with respect to the formatted version of the disparate data to provide the one or more insights associated with the disparate data. In one or more embodiments, the performing the deep learning process includes determining one or more classifications with respect to the formatted version of the disparate data to provide the one or more insights. In one or more embodiments, the performing the deep learning process includes employing a recurrent neural network to map the disparate data into multi-dimensional word embeddings. In one or more embodiments, the performing the deep learning process includes employing a network of gated-recurrent units of the recurrent neural network to provide the one or more insights. The performing the deep learning process provides one or more technical improvements such as, but not limited to, extended functionality for a computing device and/or improving accuracy of data provided to a computing device. In one or more embodiments, the method 1200 further includes retraining one or more portions of the recurrent neural network based on the one or more insights. The retraining the one or more portions of the recurrent neural network provides one or more technical improvements such as, but not limited to, improving accuracy of the recurrent neural network. In one or more embodiments, the method 1200 further includes employing a scoring model based on different metrics from historical iterations of the deep learning process to determine the one or more actions. The employing the scoring model provides one or more technical improvements such as, but not limited to, extended functionality for a computing device and/or improving accuracy of data provided to a computing device.

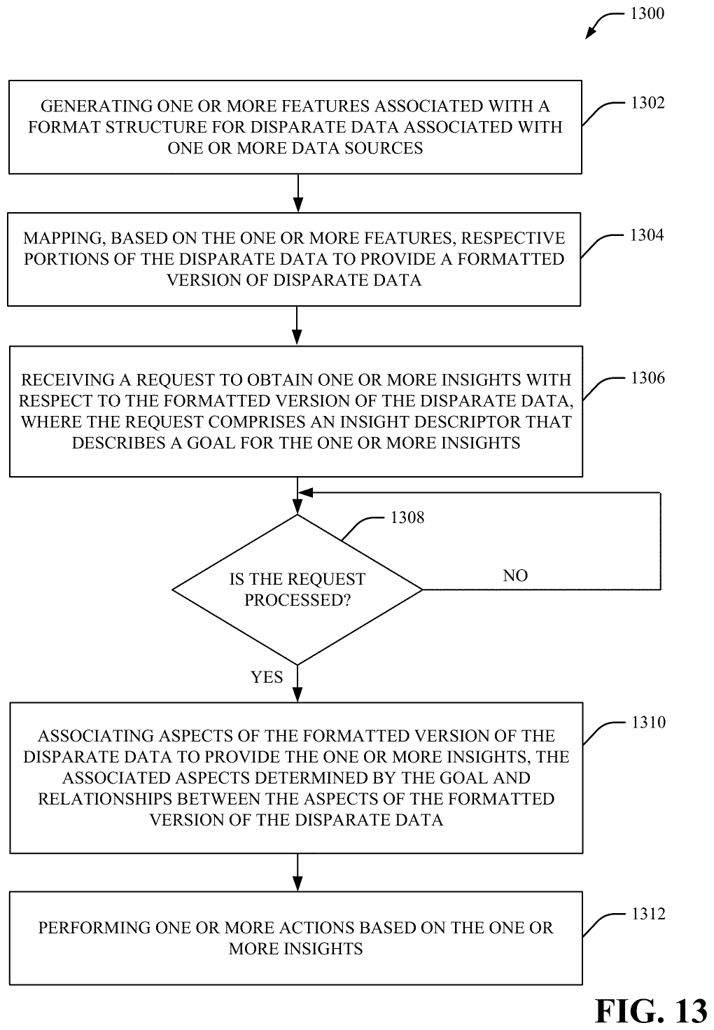

FIG. 13 illustrates a method 1300 for providing optimization related to enterprise performance management, in accordance with one or more embodiments described herein. The method 1300 is associated with the data optimization computer system 302, for example. For instance, in one or more embodiments, the method 1300 is executed at a device (e.g. the data optimization computer system 302) with one or more processors and a memory. In one or more embodiments, the method 1300 begins at block 1302 that generates (e.g., by the data mapping component 304) one or more features associated with a format structure for disparate data associated with one or more data sources. In one or more embodiments, the generating the one or more features includes generating one or more text embeddings associated with column names for the format structure. The generating the one or more features provides one or more technical improvements such as, but not limited to, extended functionality for a computing device and/or improving accuracy of data provided to a computing device.

At block 1304, based on the one or more features, respective portions of the disparate data are mapped (e.g., by the data mapping component 304) to provide a formatted version of disparate data. In one or more embodiments, the mapping includes mapping the respective portions of the disparate data based on the one or more text embeddings associated with the column names for the format structure. In one or more embodiments, the mapping additionally or alternatively includes mapping the respective portions of the disparate data based on decision tree classification associated with the column names for the format structure. In one or more embodiments, the mapping additionally or alternatively includes learning one or more vector representations of the one or more text embeddings associated with the column names. In one or more embodiments, the mapping additionally or alternatively includes calculating one or more similarity scores between one or more source column names and one or more defined target column names. In one or more embodiments, the mapping additionally or alternatively includes generating one or more text embeddings associated with column values for the format structure. In one or more embodiments, the mapping additionally or alternatively includes mapping the respective portions of the disparate data based on a set of transformer encoder layers associated with a neural network. In one or more embodiments, the mapping additionally or alternatively includes mapping the respective portions of the disparate data based on a text classifier associated with a neural network. The mapping of the respective portions of the disparate data provides one or more technical improvements such as, but not limited to, extended functionality for a computing device and/or improving accuracy of data provided to a computing device.

At 1306, a request to obtain one or more insights with respect to the formatted version of the disparate data is received (e.g., by the data mapping component 304), where the request comprises an insight descriptor that describes a goal for the one or more insights (block 1302). The request to obtain the obtain one or more insights provides one or more technical improvements such as, but not limited to, facilitating interaction with a computing device, extended functionality for a computing device and/or improving accuracy of data provided to a computing device.

At block 1308, it is determined whether the request is processed. If no, block 1308 is repeated to determine whether the request is processed. If yes, the method 1300 proceeds to block 1310. In response to the request, block 1310 associates (e.g., by the artificial intelligence component 306) aspects of the formatted version of the disparate data to provide the one or more insights, the associated aspects determined by the goal and relationships between the aspects of the formatted version of the disparate data. The associating aspects of the formatted version of the disparate data provides one or more technical improvements such as, but not limited to, extended functionality for a computing device and/or improving accuracy of data provided to a computing device. In one or more embodiments, the associating the aspects of the formatted version of the disparate data includes correlating the aspects of the formatted version of the disparate data to provide the one or more insights. In one or more embodiments, the correlating the aspects of the formatted version of the disparate data includes employing machine learning associated with a machine learning model, a ground truth model, a supervised model, a text similarity supervised model, a feature similarity unsupervised model, column name model processing, column value model processing, a classifier, and/or another type of machine learning technique.

The method 1300 also includes a block 1312 that performs (e.g., by the action component 308) one or more actions based on the one or more insights. The performing the one or more actions provides one or more technical improvements such as, but not limited to, providing a varied experience for a computing device and/or providing visual indicators via a computing device. In one or more embodiments, the one or more actions includes generating user-interactive electronic interface that renders a visual representation of the one or more insights. In one or more embodiments, the one or more actions includes transmitting, to a computing device, one or more notifications associated with the one or more insights. In one or more embodiments, the one or more actions includes predicting, based on the one or more insights, a shipping condition for an asset associated with the disparate data. In one or more embodiments, the one or more actions includes determining, based on the one or more insights, a part commodity family for unclassified purchase record data associated with the disparate data. In one or more embodiments, the one or more actions includes determining, based on the one or more insights, total spend for a part commodity family.

In one or more embodiments, the method 1300 further includes providing, based on the one or more insights, one or more mapping recommendations for the formatted version of the disparate data. Additionally or alternatively, in one or more embodiments, the method 1300 further includes updating the one or more features based on the one or more mapping recommendations. The providing the one or more mapping recommendations and/or the updating the one or more features provides one or more technical improvements such as, but not limited to, extended functionality for a computing device and/or improving accuracy of data provided to a computing device.

In one or more embodiments, the method 1300 further includes generating vocabulary ground truth data for the format structure based on one or more templates associated with historical disparate data. Furthermore, in one or more embodiments, the generating the one or more features includes generating the one or more features based on the vocabulary ground truth data associated with the one or more templates. The generating the vocabulary ground truth data provides one or more technical improvements such as, but not limited to, extended functionality for a computing device and/or improving accuracy of data provided to a computing device.

In one or more embodiments, the method 1300 further includes updating the one or more features based on a quality score associated with the one or more insights. Additionally or alternatively, in one or more embodiments, the method 1300 further includes updating the one or more features based on user feedback data associated with the one or more insights. The updating the one or more features provides one or more technical improvements such as, but not limited to, extended functionality for a computing device and/or improving accuracy of data provided to a computing device.

In one or more embodiments, the method 1300 further includes aggregating the disparate data from the one or more data sources. The aggregating the disparate data from the one or more data sources provides one or more technical improvements such as, but not limited to, extended functionality for a computing device and/or improving accuracy of data provided to a computing device. In one or more embodiments, the aggregating the disparate data includes storing the disparate data in a single data lake and/or updating data of the single data lake at one or more predetermined intervals.

In one or more embodiments, the method 1300 further includes formatting one or more portions of the disparate data, the formatting providing the formatted version of the disparate data associated with a defined format. The formatting the one or more portions of the disparate data also provides one or more technical improvements such as, but not limited to, extended functionality for a computing device and/or improving accuracy of data provided to a computing device. In one or more embodiments, the method 1300 further includes determining one or more mapping recommendations for the formatted version of the disparate data. In one or more embodiments, the formatting the one or more portions of the disparate data includes identifying one or more different data fields in the disparate data from the one or more data sources, the different data fields describing a corresponding subject. Additionally, in one or more embodiments, the formatting the one or more portions of the disparate data includes determining one or more incomplete data fields from the one or more data sources, the one or more incomplete data fields corresponding to the identified one or more different data fields. In one or more embodiments, the formatting the one or more portions of the disparate data additionally includes in accordance with a determination that the one or more determined incomplete data fields from the one or more data sources correspond to the identified one or more different data fields, adding data from an identified data field to an incomplete data field. In one or more embodiments, the formatting the one or more portions of the disparate data includes organizing the formatted version of the disparate data based on an ontological tree structure, the ontological tree structure capturing relationships among different data within the disparate data. In one or more embodiments, the method 1300 further includes comparing different data sources based on the ontological tree structure. In one or more embodiments, the associating the aspect of the formatted version of the disparate data includes traversing the ontological tree structure, the traversing associating aspects of the disparate data. The ontological tree structure provides one or more technical improvements such as, but not limited to, extended functionality for a computing device, improving accuracy of data provided to a computing device, and/or improving efficiency of a computing device.

In one or more embodiments, the method 1300 further includes performing a deep learning process with respect to the formatted version of the disparate data to provide the one or more insights associated with the disparate data. In one or more embodiments, the performing the deep learning process includes determining one or more classifications with respect to the formatted version of the disparate data to provide the one or more insights. In one or more embodiments, the performing the deep learning process includes employing a recurrent neural network to map the disparate data into multi-dimensional word embeddings. In one or more embodiments, the performing the deep learning process includes employing a network of gated-recurrent units of the recurrent neural network to provide the one or more insights. The performing the deep learning process provides one or more technical improvements such as, but not limited to, extended functionality for a computing device and/or improving accuracy of data provided to a computing device. In one or more embodiments, the method 1300 further includes retraining one or more portions of the recurrent neural network based on the one or more insights. The retraining the one or more portions of the recurrent neural network provides one or more technical improvements such as, but not limited to, improving accuracy of the recurrent neural network. In one or more embodiments, the method 1300 further includes employing a scoring model based on different metrics from historical iterations of the deep learning process to determine the one or more actions. The employing the scoring model provides one or more technical improvements such as, but not limited to, extended functionality for a computing device and/or improving accuracy of data provided to a computing device.

In some example embodiments, certain ones of the operations herein can be modified or further amplified as described below. Moreover, in some embodiments additional optional operations can also be included. It should be appreciated that each of the modifications, optional additions or amplifications described herein can be included with the operations herein either alone or in combination with any others among the features described herein.

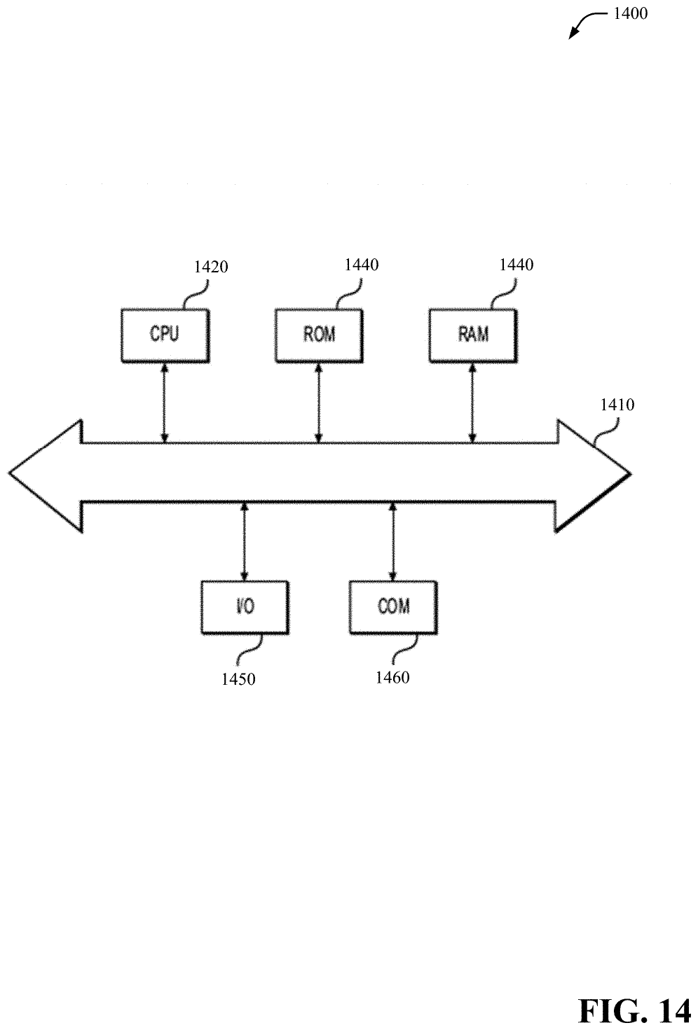

FIG. 14 depicts an example system 1400 that may execute techniques presented herein. FIG. 14 is a simplified functional block diagram of a computer that may be configured to execute techniques described herein, according to exemplary embodiments of the present disclosure. Specifically, the computer (or “platform” as it may not be a single physical computer infrastructure) may include a data communication interface 1460 for packet data communication. The platform also may include a central processing unit (“CPU”) 1420, in the form of one or more processors, for executing program instructions. The platform may include an internal communication bus 1410, and the platform also may include a program storage and/or a data storage for various data files to be processed and/or communicated by the platform such as ROM 1430 and RAM 1440, although the system 1400 may receive programming and data via network communications. The system 1400 also may include input and output ports 1450 to connect with input and output devices such as keyboards, mice, touchscreens, monitors, displays, etc. Of course, the various system functions may be implemented in a distributed fashion on a number of similar platforms, to distribute the processing load. Alternatively, the systems may be implemented by appropriate programming of one computer hardware platform.

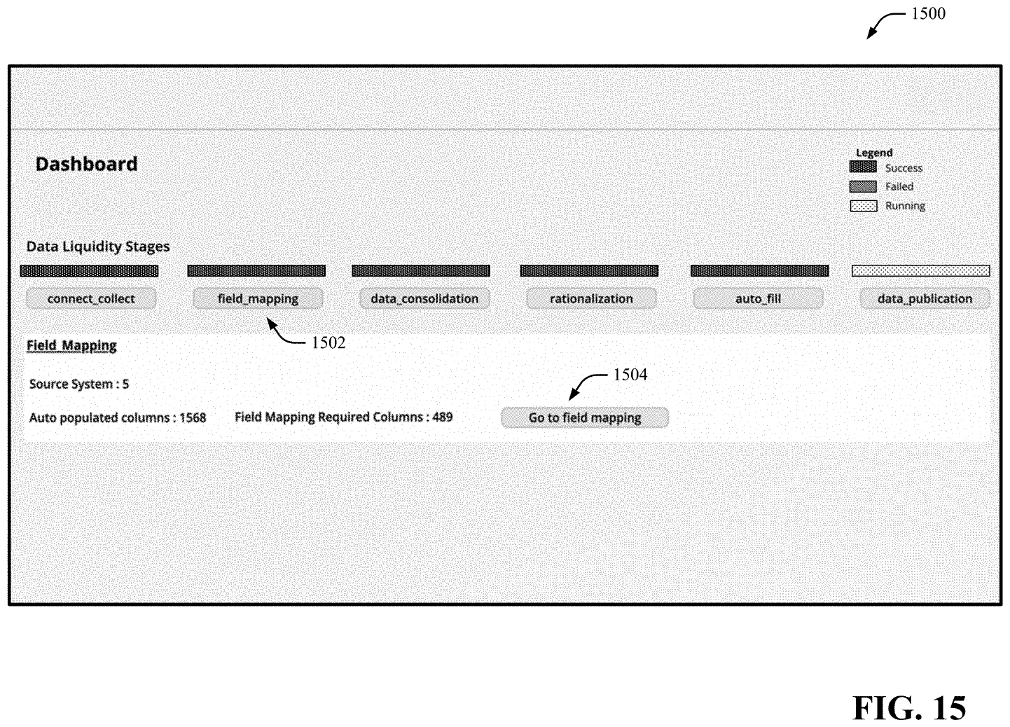

FIG. 15 illustrates an exemplary user interface 1500 according to one or more embodiments of the disclosure. In one or more embodiments, the user interface 1500 is an interactive dashboard rendered via a display of a computing device (e.g., the computing device 402). The user interface 1500 facilitates data optimization and/or data mapping with respect to the disparate data 314 stored in the one or more data sources 316. In one or more embodiments, provides field mapping 1502 to provide data liquidity with respect to the disparate data 314 stored in the one or more data sources 316. In an example, the disparate data 314 stored in the one or more data sources 316 includes data from five data sources and/or data associated with 1568 auto populated columns. Furthermore, in an example, the field mapping 1502 is associated with field mapping of 489 columns of data. In one or more embodiments, the user interface 1500 includes an interactive user interface element 1504 that initiates field mapping (e.g., initiates generation of the request 320) associated with the data optimization computer system 302, according to one or more embodiments disclosed herein.

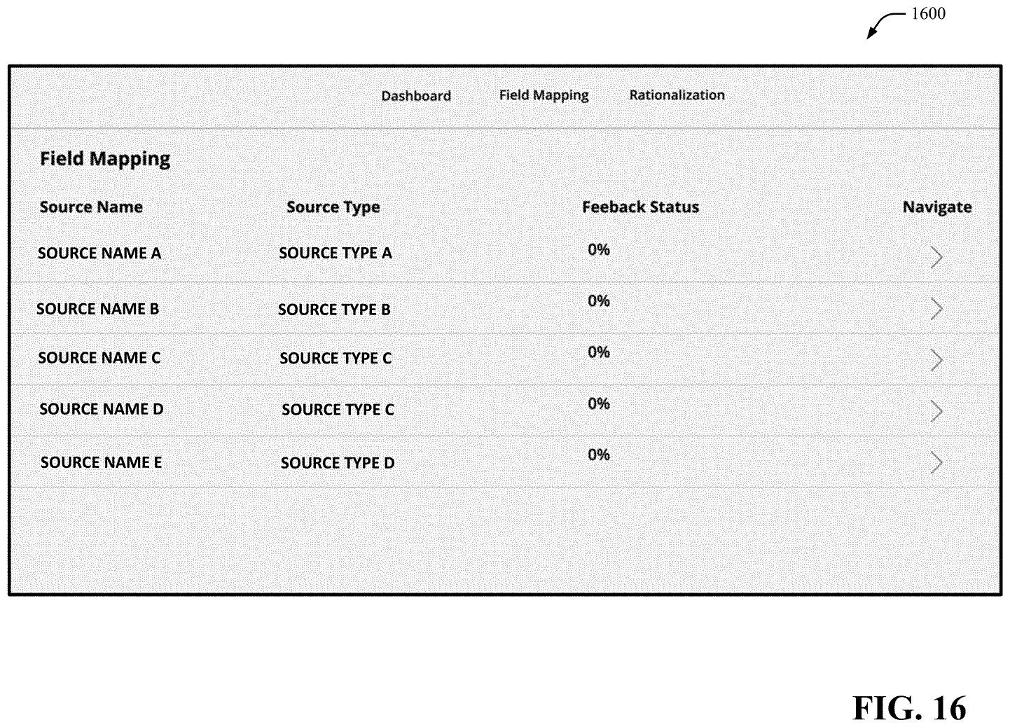

FIG. 16 illustrates an exemplary user interface 1600 according to one or more embodiments of the disclosure. In one or more embodiments, the user interface 1600 is an interactive dashboard rendered via a display of a computing device (e.g., the computing device 402). The user interface 1600 facilitates field mapping with respect to the disparate data 314 stored in the one or more data sources 316. In one or more embodiments, the one or more data sources 316 include a first data source (e.g., SOURCE NAME A) associated with a first source type (e.g., SOURCE TYPE A), a second data source (e.g., SOURCE NAME B) associated with a second source type (e.g., SOURCE TYPE B), a third data source (e.g., SOURCE NAME C) associated with a third source type (e.g., SOURCE TYPE C), a fourth data source (e.g., SOURCE NAME D) associated with the third source type (e.g., SOURCE TYPE C), and a fifth data source (e.g., SOURCE NAME E) associated with a fourth source type (e.g., SOURCE TYPE D). In one or more embodiments, the field mapping associated with the user interface 1600 is realized via the data optimization computer system 302, according to one or more embodiments disclosed herein. In one or more embodiments, the field mapping associated with the user interface 1600 is performed in a reduced amount of time (e.g., seconds, minutes, hours, days or weeks) as compared to conventional data processing systems.

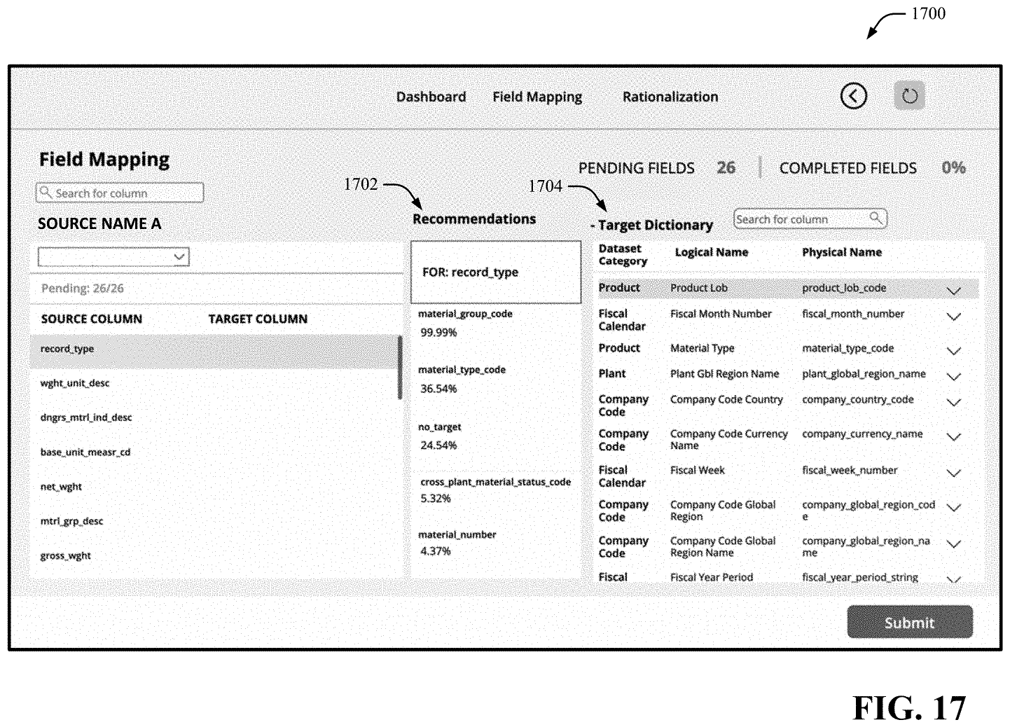

FIG. 17 illustrates an exemplary user interface 1700 according to one or more embodiments of the disclosure. In one or more embodiments, the user interface 1700 is an interactive dashboard rendered via a display of a computing device (e.g., the computing device 402). The user interface 1700 facilitates field mapping with respect to the disparate data 314 stored in the one or more data sources 316. In one or more embodiments, the field mapping associated with the user interface 1700 is realized via the data optimization computer system 302, according to one or more embodiments disclosed herein. In one or more embodiments, the field mapping associated with the user interface 1700 is performed with respect to source columns and/or target columns for the disparate data 314 stored in the one or more data sources 316. In one or more embodiments, the user interface 1700 provides recommendations 1702 for particular source columns (e.g., recommendations for a record type source column, etc.). In one or more embodiments, the field mapping associated with the user interface 1700 is performed based on a target dictionary associated with a dataset category, a logical name, a physical name, and/or other information for a target column.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments can be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

It is to be appreciated that ‘one or more’ includes a function being performed by one element, a function being performed by more than one element, e.g., in a distributed fashion, several functions being performed by one element, several functions being performed by several elements, or any combination of the above.

Moreover, it will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

The systems, apparatuses, devices, and methods disclosed herein are described in detail by way of examples and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these the apparatuses, devices, systems or methods unless specifically designated as mandatory. For ease of reading and clarity, certain components, modules, or methods may be described solely in connection with a specific figure. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such. Any failure to specifically describe a combination or sub-combination of components should not be understood as an indication that any combination or sub-combination is not possible. It will be appreciated that modifications to disclosed and described examples, arrangements, configurations, components, elements, apparatuses, devices, systems, methods, etc. can be made and may be desired for a specific application. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Throughout this disclosure, references to components or modules generally refer to items that logically can be grouped together to perform a function or group of related functions. Like reference numerals are generally intended to refer to the same or similar components. Components and modules can be implemented in software, hardware, or a combination of software and hardware. The term “software” is used expansively to include not only executable code, for example machine-executable or machine-interpretable instructions, but also data structures, data stores and computing instructions stored in any suitable electronic format, including firmware, and embedded software. The terms “information” and “data” are used expansively and includes a wide variety of electronic information, including executable code; content such as text, video data, and audio data, among others; and various codes or flags. The terms “information,” “data,” and “content” are sometimes used interchangeably when permitted by context.

The hardware used to implement the various illustrative logics, logical blocks, modules, and circuits described in connection with the aspects disclosed herein can include a general purpose processor, a digital signal processor (DSP), a special-purpose processor such as an application specific integrated circuit (ASIC) or a field programmable gate array (FPGA), a programmable logic device, discrete gate or transistor logic, discrete hardware components, or any combination thereof designed to perform the functions described herein. A general-purpose processor can be a microprocessor, but, in the alternative, the processor can be any processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration. Alternatively, or in addition, some steps or methods can be performed by circuitry that is specific to a given function.

In one or more example embodiments, the functions described herein can be implemented by special-purpose hardware or a combination of hardware programmed by firmware or other software. In implementations relying on firmware or other software, the functions can be performed as a result of execution of one or more instructions stored on one or more non-transitory computer-readable media and/or one or more non-transitory processor-readable media. These instructions can be embodied by one or more processor-executable software modules that reside on the one or more non-transitory computer-readable or processor-readable storage media. Non-transitory computer-readable or processor-readable storage media can in this regard comprise any storage media that can be accessed by a computer or a processor. By way of example but not limitation, such non-transitory computer-readable or processor-readable media can include random access memory (RAM), read-only memory (ROM), electrically erasable programmable read-only memory (EEPROM), FLASH memory, disk storage, magnetic storage devices, or the like. Disk storage, as used herein, includes compact disc (CD), laser disc, optical disc, digital versatile disc (DVD), floppy disk, and Blu-ray Disc™, or other storage devices that store data magnetically or optically with lasers. Combinations of the above types of media are also included within the scope of the terms non-transitory computer-readable and processor-readable media. Additionally, any combination of instructions stored on the one or more non-transitory processor-readable or computer-readable media can be referred to herein as a computer program product.

Many modifications and other embodiments of the inventions set forth herein will come to mind to one skilled in the art to which these inventions pertain having the benefit of teachings presented in the foregoing descriptions and the associated drawings. Although the figures only show certain components of the apparatus and systems described herein, it is understood that various other components can be used in conjunction with the supply management system. Therefore, it is to be understood that the inventions are not to be limited to the specific embodiments disclosed and that modifications and other embodiments are intended to be included within the scope of the appended claims. Moreover, the steps in the method described above can not necessarily occur in the order depicted in the accompanying diagrams, and in some cases one or more of the steps depicted can occur substantially simultaneously, or additional steps can be involved. Although specific terms are employed herein, they are used in a generic and descriptive sense only and not for purposes of limitation.

It is intended that the specification and examples be considered as exemplary only, with a true scope and spirit of the disclosure being indicated by the following claims.

What is claimed is:

1. A method, comprising:
at a device with one or more processors and a memory:
receiving a request to obtain one or more insights with respect to a formatted version of disparate data associated with one or more data sources, the request comprising:
an insight descriptor, the insight descriptor describing a goal for the one or more insights; and
in response to the request,
correlating aspects of the formatted version of the disparate data to provide the one or more insights, the associated aspects determined by the goal and relationships between the aspects of the formatted version of the disparate data; and
performing one or more actions based on the one or more insights.

2. The method of claim 1, further comprising:
aggregating the disparate data from the one or more data sources;
formatting one or more portions of the disparate data, the formatting providing the formatted version of the disparate data associated with a defined format; and
determining one or more mapping recommendations for the formatted version of the disparate data.

3. The method of claim 1, the formatting the one or more portions of the disparate data comprising:
identifying one or more different data fields in the disparate data from the one or more data sources, the one or more different data fields describing a corresponding subject;
determining one or more incomplete data fields from the one or more data sources, the one or more incomplete data fields corresponding to the identified one or more different data fields; and
in accordance with a determination that the one or more determined incomplete data fields from the one or more data sources correspond to the identified one or more different data fields, adding data from an identified data field to an incomplete data field.

4. The method of claim 1, the formatting the one or more portions of the disparate data comprising:
organizing the formatted version of the disparate data based on an ontological tree structure, the ontological tree structure capturing relationships among different data within the disparate data.

5. The method of claim 1, further comprising:
generating one or more features associated with a format structure for the disparate data associated with the one or more data sources; and
mapping, based on the one or more features, respective portions of the disparate data to provide the formatted version of the disparate data.

6. The method of claim 5, further comprising:
providing, based on the one or more insights, one or more mapping recommendations for the formatted version of the disparate data; and
updating the one or more features based on the one or more mapping recommendations.

7. The method of claim 5, further comprising:
generating one or more text embeddings associated with column names for the format structure,
the mapping comprising mapping the respective portions of the disparate data based on the one or more text embeddings associated with the column names for the format structure.

8. The method of claim 1, further comprising:
generating user-interactive electronic interface that renders a visual representation of the one or more insights.

9. The method of claim 1, further comprising:
determining one or more features associated with the one or more insights; and
predicting, based on the one or more features associated with the one or more insights, a condition for an asset associated with the disparate data.

10. A system, comprising:
one or more processors;
memory; and
one or more programs stored in the memory, the one or more programs including instructions configured to:
receive a request to obtain one or more insights with respect to a formatted version of disparate data associated with one or more data sources, the request comprising:
an insight descriptor, the insight descriptor describing a goal for the one or more insights; and
in response to the request,
correlate aspects of the formatted version of the disparate data to provide the one or more insights, the associated aspects determined by the goal and relationships between the aspects of the formatted version of the disparate data; and
perform one or more actions based on the one or more insights.

11. The system of claim 10, the one or more programs further including instructions configured to:
aggregate the disparate data from the one or more data sources;
format one or more portions of the disparate data, the formatting providing the formatted version of the disparate data associated with a defined format; and
determine one or more mapping recommendations for the formatted version of the disparate data.

12. The system of claim 10, the one or more programs further including instructions configured to:
identify one or more different data fields in the disparate data from the one or more data sources, the one or more different data fields describing a corresponding subject;
determine one or more incomplete data fields from the one or more data sources, the one or more incomplete data fields corresponding to the identified one or more different data fields; and
in accordance with a determination that the one or more determined incomplete data fields from the one or more data sources correspond to the identified one or more different data fields, add data from an identified data field to an incomplete data field.

13. The system of claim 10, the one or more programs further including instructions configured to:
organize the formatted version of the disparate data based on an ontological tree structure, the ontological tree structure capturing relationships among different data within the disparate data.

14. The system of claim 10, the one or more programs further including instructions configured to:
generate one or more features associated with a format structure for the disparate data associated with the one or more data sources; and
map, based on the one or more features, respective portions of the disparate data to provide the formatted version of the disparate data.

15. The system of claim 14, the one or more programs further including instructions configured to:
provide, based on the one or more insights, one or more mapping recommendations for the formatted version of the disparate data; and
update the one or more features based on the one or more mapping recommendations.

16. The system of claim 14, the one or more programs further including instructions configured to:
generate one or more text embeddings associated with column names for the format structure,
the map comprising mapping the respective portions of the disparate data based on the one or more text embeddings associated with the column names for the format structure.

17. A non-transitory computer-readable storage medium comprising one or more programs for execution by one or more processors of a device, the one or more programs including instructions which, when executed by the one or more processors, cause the device to:
receive a request to obtain one or more insights with respect to a formatted version of disparate data associated with one or more data sources, the request comprising:
an insight descriptor, the insight descriptor describing a goal for the one or more insights; and
in response to the request,
correlate aspects of the formatted version of the disparate data to provide the one or more insights, the associated aspects determined by the goal and relationships between the aspects of the formatted version of the disparate data; and
perform one or more actions based on the one or more insights.

18. The non-transitory computer-readable storage medium of claim 17, the one or more programs further including instructions which, when executed by the one or more processors, cause the device to:
identify one or more different data fields in the disparate data from the one or more data sources, the one or more different data fields describing a corresponding subject;
determine one or more incomplete data fields from the one or more data sources, the one or more incomplete data fields corresponding to the identified one or more different data fields; and
in accordance with a determination that the one or more determined incomplete data fields from the one or more data sources correspond to the identified one or more different data fields, add data from an identified data field to an incomplete data field.

19. The non-transitory computer-readable storage medium of claim 17, the one or more programs further including instructions which, when executed by the one or more processors, cause the device to:
organize the formatted version of the disparate data based on an ontological tree structure, the ontological tree structure capturing relationships among different data within the disparate data.

20. The non-transitory computer-readable storage medium of claim 17, the one or more programs further including instructions which, when executed by the one or more processors, cause the device to:
generate one or more features associated with a format structure for the disparate data associated with the one or more data sources; and
map, based on the one or more features, respective portions of the disparate data to provide the formatted version of the disparate data.
